(19) United States
(12) Patent Application Publication
(10) Pub. No.: US 2012/0322041 A1
(43) Pub. Date: Dec. 20, 2012

(54) METHOD AND APPARATUS FOR PRODUCING AND DELIVERING CUSTOMIZED EDUCATION AND ENTERTAINMENT

(76) Inventor: Jordan K. Weisman, Bellevue, WA (US)

(21) Appl. No.: 13/332,232

(22) Filed: Dec. 20, 2011

Related U.S. Application Data
(60) Provisional application No. 61/430,147, filed on Jan. 5, 2011.

(51) Int. Cl. G09B 5/00

(52) U.S. Cl. 434/308

(57) ABSTRACT

A parent provides information regarding a child and other family members to a system. The information is then used to create customized assemblages of linear and interactive media, which may be further personalized for that child's entertainment and education. The customized and personalized episode so assembled persists and can be replayed indefinitely. New episodes are created regularly (e.g., daily), and can be based on the child's age, preferences, and performance while experiencing previous episodes. Scheduled events (e.g., birthdays, starting school), local current events (e.g., weather), the current situation (e.g., current location, time of day), etc. may also influence the creation of new episodes. While monitoring the child's progress, the system provides to a parent suggestions for activities related to the child's recent episodes.

### CROSS REFERENCE TO RELATED APPLICATIONS

This application claims priority to U.S. Provisional Patent Application No. 61/430,147 filed Jan. 5, 2011.

### FIELD OF THE INVENTION

The present invention relates generally to a system and method for providing playlists. More particularly, the invention relates to a system and method for providing customized playlists based on a parent and child's age, preferences, performance, needs, environment, schedule, and the other factors.

### STATEMENT REGARDING FEDERALLY SPONSORED RESEARCH OR DEVELOPMENT

Not Applicable

### REFERENCE TO COMPUTER PROGRAM LISTING APPENDICES

Not Applicable

### BACKGROUND OF THE INVENTION

Since 1969, generations of children, an estimated 77 million as of 2008, have benefited from the Children's Television Workshop (CTW, now Sesame Workshop) production of Sesame Street. The result of a collaboration by visionary philanthropic foundations with talented writers, musicians, artists (puppeteers and animators), actors, executives, and technicians, all directing television technology with the goal to “master the addictive qualities of television and do something good with them” (Michael Davis, Street Gang: The Complete History of Sesame Street, Viking Penguin, NY, 2008).

Increasingly, however, the technologies consuming the day's hours for children are interactive, such as video games, computer games, Internet browsing, and the like. Often, children have access to a personal computer, laptop computer, console gaming system (e.g., the Wii by Nintendo of America Inc., Redmond, Wash.), handheld gaming system (e.g., the Nintendo DSi, also by Nintendo), personal digital assistant (PDA) such as a tablet computer (e.g., the iPad, by Apple, Inc., Cupertino, Calif.), or a smartphone (e.g., the iPhone, also by Apple, or those based on the Android operating system by Google Inc., Mountain View, Calif.). There is a need to master the addictive qualities of these computer technologies and do more good with them: To provide a continually refreshed wellspring of entertainment and education suitable for an audience similar to that of Sesame Street.

While embodiments of the present invention can employ any of the computer technologies listed above, the discussion herein will assume a PDA format (e.g., tablet or smartphone) because a PDA's size and weight is most easily manipulated by a child. It should be understood that this is by way of example and not limitation.

PDAs are typically capable of Internet access, can offer browsing, and can load and run application programs (apps). In some cases, apps are platform specific (e.g., apps for the iPhone can only run on devices that use the same operating system as the iPhone: iOS by Apple. Other apps are designed to operate on many platforms (e.g., apps written in Adobe Flash, Microsoft Silverlight, Sun's Java, by Adobe Systems, Mountain View, Calif.; Microsoft Corporation, Redmond, Wash.; and Sun Microsystems, Santa Clara, Calif.—now a subsidiary of Oracle, Redwood Shores, Calif.; all respectively). Further, a range of open software standards can achieve results similarly rich and interactive. These include SVG (Scalable Vector Graphics), SMIL (Synchronized Multimedia Integration Language), combined with a scripting language (e.g., ECMAScript or JavaScript) and audio and video streams, such as those supported natively in HTML5, an improved hypertext markup language already supported by many browsers and undergoing standardization by the World Wide Web Consortium (W3C), Cambridge, Mass.

A drawback to the broadcast format of Sesame Street and similar children's television programming such as Yo Gabba Gabba on the Nickelodeon channel (operated by MTV Networks, New York, N.Y.), is that they cannot take into account the individual needs, interests, and preferences of individual members of its audience. This is true whether the program is viewed as a television broadcast or if it is streamed on the Internet or downloaded via a system like iTunes (also by Apple). There is a need to customize and personalize presentations for individual viewers in order to make each episode more relevant and contain more emotional and educational impact for each viewer. Tracking an audience member's performance and reaction to episode segments allows for creation of future episodes that can foster improvement where the individual had difficulty or accelerate as warranted by the individual's performance. Audience members can review favorite episodes or segments for entertainment or to bolster skills.

A different aspect of this same issue is that as a Sesame Street or Yo Gabba Gabba audience member matures, the broadcast format show is unable to provide educational, emotional, or social developmental support, except by offering a different show (e.g., The Electric Company, also by CTW).

The children's television format also represents an opportunity for a parent to keep children entertained, but the parent is left to hope that the programming is at least non-harmful, though in the case of Sesame Street, after a number of decades, thousands of studies had been reported indicating that it was substantially beneficial to its perennial young audience. There is a need for a parent to have a more contemporaneous insight into how beneficial the selected entertainment is for their child.

### SUMMARY OF THE INVENTION

The present invention relates generally to a system and method for providing education and entertainment customized and personalized for each child. The invention makes use of information and media provided by a parent (or supervision adult) about the child, other family members, and the child's environment (e.g., neighborhood, school) and family activities (e.g., visits by relative, vacations, etc.). That information is used to select from a library of media segments, which may be augmented with the parent-provided media or with the information itself. The selected media segments are compiled into a daily episode, tailored to the child, which is stored for later playback.

The parent may be tasked to answer specific questions about the family and child to provide the information useful for selecting and augmenting media segments. The parent may be tasked to provide pictures of specific people (e.g., family members and/or teachers) or places (e.g., the child's room and/or the family's kitchen) or audio recordings (e.g., the family pet barking, mom reciting a poem and/or dad laughing) designed to augment particular media segments.

The overall structure of the episode is based on a template, the template being designed in the timing and sequencing of segment presentation to maximally retain the attention of the child and to engage the child's interest. The actual selection of which media segments are used for each segment called out in an episode template can be different for different children, as the selection is customized on the basis of each child's interests, needs, performance, age, preferences, environment, schedule, and other factors.

A related aspect is that individual media segments may be further personalized through the inclusion of user generated content, e.g., a picture of the child's home, or a recording of mom's laugh.

As used herein and throughout, the terms “customize” and “personalize” and forms thereof have these particular meanings: “Customize” is to select the segments that are assembled to make an episode on the basis of data relating to the target child. “Personalize” is to augment a segment with user generated content relating to the target child.

Another aspect of the present invention is to keep the parent informed of the child's progress, interests, and summarize each show so the parent is not required to watch the show in order to understand what is going on.

Still another aspect of the invention is to provide suggested activities that the parent can undertake with the child, e.g., conversation topics, dinnertime games, etc., that can be synchronized with concepts presented in recent or upcoming episodes.

Part of the information that the invention can employ is a calendar, which can be populated by common events (e.g., the appropriate national, school, or religious holidays and events) and by family-specific events (e.g., birthdays, trips, visits by relatives, an expectant mom's due date and doctor visits). Current events, such as the first snow and a school “snow day” (school is closed due to weather), can be recognized by the invention based on the location of the child's residence or other information. Such events can be used by the system to trigger use of specific media segments or episode templates to produce presentations more connected to the child's real world.

The present invention also provides mechanisms for a parent to interact with the child in the context of the PDA, for example by leaving messages or sending virtual gifts.

The invention provides incentives as the child progresses and makes achievements, for example in the form of virtual stickers. Further, a parent can select goals for the child to achieve and may purchase or otherwise provide real world incentives in advance, which can then be awarded by the invention when the child achieves a target goal or level of performance.

As the child develops, the form of the episode provided can change from an essentially linear presentation, to formats offering more sophisticated and interactive navigation, for example a presentation that branches based on the child's input, or a map-based game-world presentation (e.g., a virtual reality environment where media segments are presented at different locations within a game world).

The invention employs the range of sensors available on a PDA, such as a touchscreen, camera, microphone, keypad, joypad, etc. for use in the selection of and navigation within an episode, and for interaction within individual media segments.

### BRIEF DESCRIPTION OF THE DRAWINGS

These and other aspects of the present invention will be apparent upon consideration of the following detailed description taken in conjunction with the accompanying drawings, in which like referenced characters refer to like parts throughout, and in which:

FIG. 1 is a block diagram of a system for creating and delivering customized and personalized learning and play activities to a child using a database of media and information about the child and his family, while allowing monitoring of the child's performance by a parent;

FIG. 2 is an example schema for a portion of the database that tracks accounts and family members, and information associated with them;

FIG. 3 is an example schema for the portion of the database that tracks episode templates, media segments for customized use with those templates, and personalizations made for each child;

FIG. 4 is an example schema for the portion of the database tracking the media assets corresponding to each media segment;

FIG. 5 is an example schema for the portion of the database listing characters that can appear in segments and information about those characters;

FIG. 6 is an example schema for the portion of the database listing a variety of predefined calendars listing events, and additional personalized events;

FIG. 7 is an example schema for the portion of the database tracking current events about a child's environment and/or family members;

FIG. 8 is a data flow diagram for the editor module selecting an episode template and creating a customized selection of segments for that episode, and personalizing those segments;

FIG. 9 is an example flowchart for the process performed by the editor module;

FIG. 10 an example schema for the portion of the database tracking available and ready incentives;

FIG. 11 is an example data flow diagram for the player module presenting a customized and personalized episode;

FIG. 12 is a schematic diagram of an alternative map based virtual reality presentation of a customized and personalized episode;

FIG. 13 is a schematic diagram of an alternative branching presentation of a customized and personalized episode;

FIG. 14 is a user interface menu map for the parental monitoring and participation functions and the associated data tables;

FIG. 15 an example storyboard for a customized and personalized interactive media segment; and,

FIG. 16 shows two example screens for evaluation and navigation of customized and personalized content.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

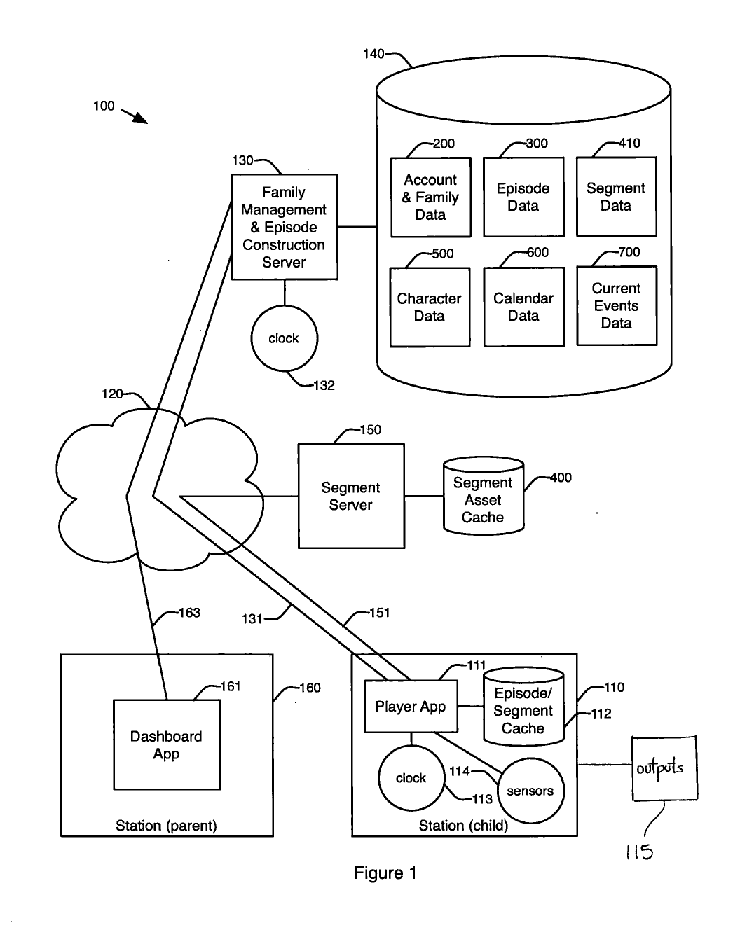

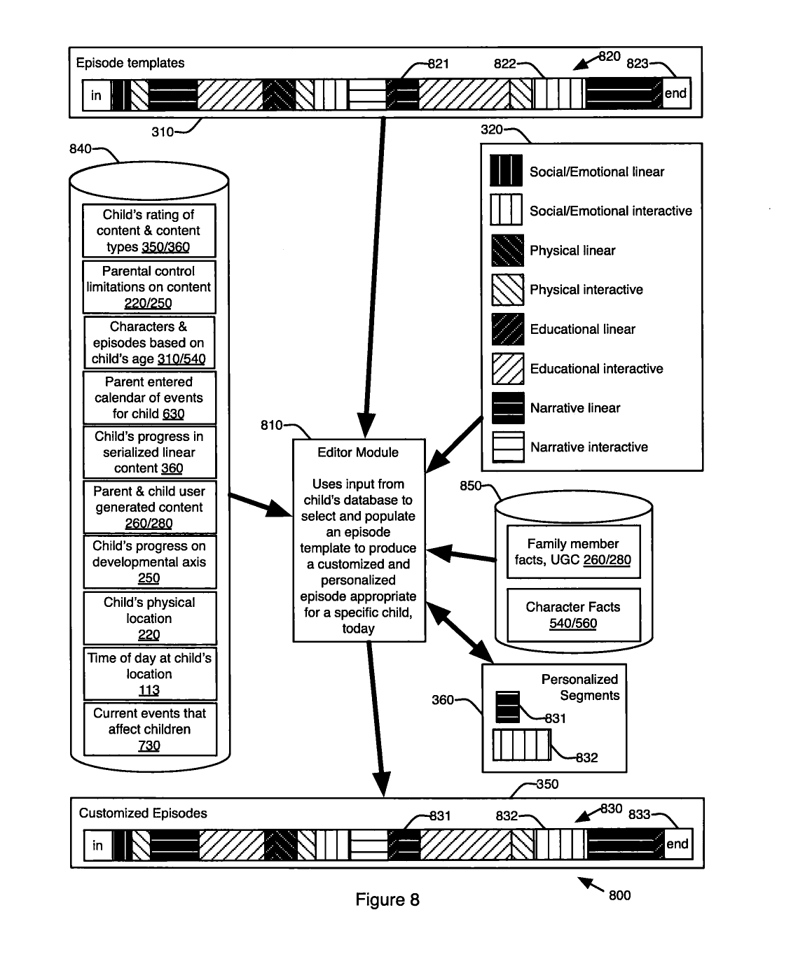

Referring to FIG. 1, episode presentation system 100 comprises child's station 110, parent's station 160 (which may be the same as child's station 110), and episode server 130, to which each station 110, 160 has connection 131, 163 respectively. Episode server 130 comprises editor module 810 (see FIG. 8 and accepts information and user-generated media from the stations 110, 160, which is then used by the editor module 810 to provide customized and personalized episodes to the child station 110. In the example embodiment shown, the child's station 110 also has connection 151 to media segment server 150, which is particularly optimized for delivering streaming media or large media files, though this division of function is not required and in some embodiments may be performed over connection 131 with episode server 130. The connections 131, 151, 163 among servers 130, 150 and stations 110, 160 may comprise the Internet 120 or other communications channel, and may further comprise wireless links.

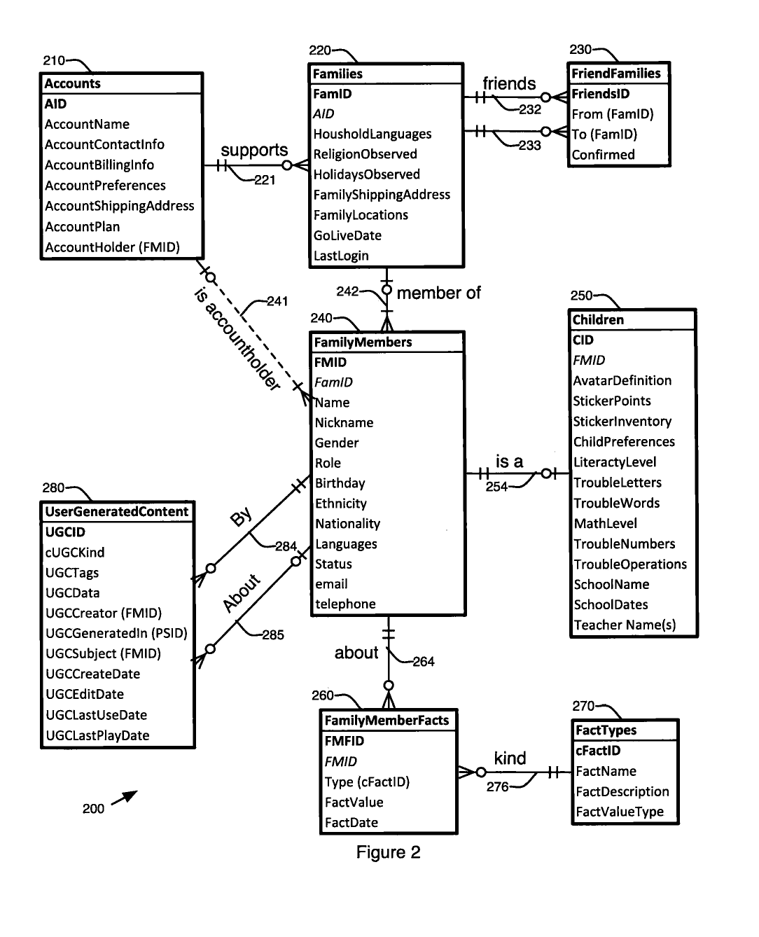

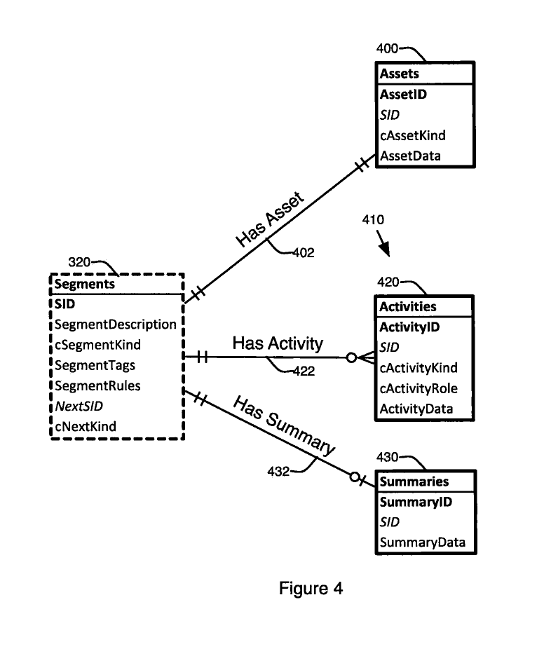

Episode server 130 has access to database 140 which comprises accounting and family data 200, episode data 300, segment data 410, character data 500, calendar data 600, and current events data 700, each discussed in greater detail below in conjunctions with FIGS. 2-7, respectively. Media segment server 150 has access to database 400, also known as the segment asset cache 400, containing the media assets (e.g., audio, video, interactive applications) for the media segments. Segment asset cache 400 is discussed in detail below, in conjunction with FIG. 4. In those embodiments where the functions of media segment server 150 is performed by episode server 130, segment asset cache 400 would be located within database 140.

Episode server 130 performs the functions of accepting information about a child from parent's station 160, and using that information to customize an episode comprising a plurality of media segments which may be personalized. The customized and personalized episode, including the media segments (which may be delivered by segment server 150) is delivered to the child's station 110 for presentation to the child. Episode server 130 has access to clock 132, which can provide time and date information, for example for use in applying information from calendar data 600.

Child's station 110 comprises a player application 111 (also called herein the “player app”); a cache 112 of episodes and media segments that enhances performance and allows offline operation rather than requiring persistence of connections 131, 151; clock 113 providing the current time and date; and sensors 114 for accepting input from the child. Station 110 further comprises audio and video outputs 115 for providing the presentation of each customized and personalized episode.

Sensors 114 comprise at least, location sensors (GPS or proximity sensors) one of a keypad, joypad, touchscreen, camera, microphone, compass, and accelerometers, to allow navigation, control, and input by the child. Sensors 114 may further comprise a compass and/or location sensors such as GPS or proximity detection using cell towers or Wi-Fi transmitters, for detecting the current location of child's station 110.

Some of the media segments may be interactive and may accept input from the camera (one of sensors 114). For example, a segment may cover the topic of color and the child may be asked to take pictures of colored objects, which can then be automatically analyzed for the correct color content. A segment may concern a location or object, e.g., the kitchen, and the camera may be used to take pictures which can then be matched against previously supplied photographs of the child's family's kitchen. The camera may be used to record the child dancing to music supplied in a media segment, the video being stored for later use augmenting the same or different media segment. The camera may be used to capture barcodes, for example Microsoft Tag (by Microsoft) or QR Codes (by Denso-Wave, Kariya, Aichi, Japan) for interacting with toys, merchandise, or magazines. The camera may track markers printed at home or on toys for augmented reality play. A media segment may use the camera to detect the ambient light level of the environment (e.g., whether the child is in a bright area, or in a dark room).

Some of the media segments may accept input from the microphone. A segment may prompt the child to sing along, a recording being stored for use to personalize a future segment. A segment may prompt the child to read words, sentences, or propose rhyming words. Voice recognition may then determine the correctness of the response. The child may be tasked with recording other family members. A segment may use the microphone as a controller, e.g., the volume registered by blowing across the microphone may be the interactive input. A media segment may use the microphone to determine the ambient sound level of the current environment.

Some media segments may accept input from the accelerometers or compass, for example, to measure physical activity (jumping up & down, etc.). Other uses would be to detect orientation of the PDA, for example while the child lays down holding the PDA overhead to generate pretend stars and sky; or for interaction using tilt-based control.

Some media segments may accept input from the location sensors (GPS, proximity sensors) for use in establishing whether the child is at “home” or some different location. Another media segment may use the location sensors for a virtual character hunt (e.g., hide and seek of a virtual character). Location sensors can inform a media segment of the current location, which in turn can be used to determine the current weather in the child's neighborhood for use in the media segment. Other media segments may use the location sensors to determine whether the child is stationary or moving (i.e., in a car/bus/train/airplane).

A media segment may use clock 113 to determine whether it is day or night, morning or evening, lunchtime, a weekday or weekend. In conjunction with information about other family members, the current time from clock 113 may determine whether the media segment is playing during school hours or not, and may indicate whether older siblings will be arriving home from school soon.

Parent's station 160 may have similar capabilities to those of child's station 110, though clock 113 and sensors 114 are not shown in FIG. 1 in parent's station 160. Parent's station 160 comprises dashboard application 161, which provides for the interaction of the parent with episode server 130.

Additionally, parent's station 160 and child's station 110 may be implemented as the same device, with applications 111 and 161 being distinct applications, or alternatively, the different aspects of a common application.

Dashboard application 161 (also called herein the “dashboard app”) provides the functions of entering family information into database 140 (e.g., account and family data 200 and calendar data 600), and for uploading user-generated media into database 140 (family data 200).

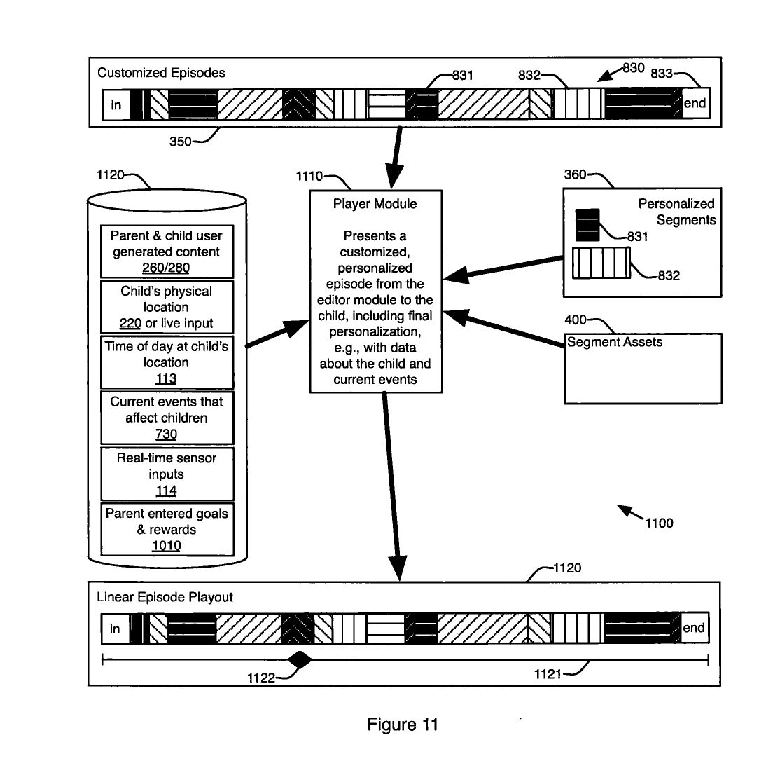

Player app 111 comprises player module 1110 (shown in FIG. 11). Player module 1110 can play media segments prescribed by the editor module 810 (see FIG. 8) as an episode, and may evaluate and report the child's performance and preferences back to episode server 130 to be noted in family data 200. Subsequently, dashboard app 161 may allow a parent to review the child's progress.

Both dashboard app 161 and player app 111 may be implemented as applications native to their corresponding stations 160, 110 (e.g., a native iPhone or iPad app for use on Apple PDA devices, or as a computer game for use on a game console, or application program on a PC). Alternatively, apps 161 and 111 may be implemented as web pages or web applications running in a browser on the corresponding stations. Some embodiments may provide heterogeneous implementations of apps 111 and 161 (e.g., player app 111 may be a native application while dashboard app 161 may be implemented as browser-based).

Database 140 contains information about accounts, families, family members, children, calendars, current events, media segments, characters in or usable by segments, episode templates, episodes and media segments as they are customized and personalized for a child. Actual media segment assets are kept in segment asset cache 400 (but in some embodiments may be kept in database 140 instead). One structure for database 140 is discussed here, in conjunction with FIGS. 2-7.

FIG. 2 shows a detailed schema for family data 200 represented within database 140. As a matter of design choice, database 140 is shown as a relational database, with tables and relationships described using crow's foot notation, so as to clearly and conveniently illustrate the invention and provide a workable example implementation of the present invention. Those skilled in the art will recognize that other paradigms and design choices may be used in alternative embodiments.

Family data 200 comprises accounts table 210, families table 220, friend-families table 230, family members table 240, children table 250, family member facts table 260, fact types table 270, and user generated content table 280. Each table contains a record for each instance of the named entity; for example, a unique record in children table 250 will represent each child known to the system.

Each table is described by its name (e.g., Accounts), and a list of data fields that may appear for each record within the table. The convention used here is that the key field(s) that uniquely identify each record within the table is shown in bold type (e.g., AID) and is commonly an abbreviation of the table name and “identifier”, hence “Accounts Identifier” becomes “AID”). The convention also provides that foreign key field(s) are shown in italics (e.g., the “AID” field in families table 220). Foreign key fields allow one record in a table to be related to other records in the same or different tables. In some cases, a foreign key field name is necessarily more descriptive and name of the related record's key field is shown in parentheses (e.g., the “UGCCreator” and “UGCSubject” fields in user generated content table 280 each create a different relationship to records in the family members table 240, using the “FMID” key field for the records in the family members table 240). The relationships so established and some of their properties are illustrated using the well-known crow's-foot notation to indicate whether a relationship is required or optional, and whether it may be one-to-one, one-to-many, or many-to-many.

Account table 210 contains information about a subscriber account including the unique record identifier key field “AID”, an account name, contact information (e.g., phone numbers, email addresses, etc. of the account holder), billing information (e.g., credit card information, a billing address, etc.), a preferences field for storing account holder preferences, and other information such as shipping addresses, and a subscription plan selection (e.g., whether the subscription is annual, monthly, etc.). In some embodiments, a reference to a record in the family members table 240 of the account holder, thereby forming “is accountholder” relationship 241 may be used, since much of the information about the account holder (e.g., name, email, telephone) might otherwise need to be duplicated. Use of such a relationship rather than including explicit accountholder information within the record in account table 210 is an example of a design choice.

Families table 220 records information about each family, each family record being uniquely identified by key field “FamID”. Each family record is associated with an account record by foreign key field “AID”, forming “supports” relationship 221. While it might generally be the case that each family would have its own account, it is possible that an account might support multiple families, for example, one account created and paid for by a grandfather could support a separate family for each of his children, thereby providing access to the present invention for each of his grandchildren.

Family records in table 220 provide information about each family: listing which languages are spoken in the household, which religion is observed, which holidays are observed, a shipping address for the family (which by the above example, might be different from the account shipping address), locations frequented by the family (e.g., home, schools, vacation spots, relatives houses, etc., where the family frequently or on occasion finds itself), the date when the family record was created (the “go-live date”), and the time and date of last login. Many of the fields listed here may be skipped, and others substituted or added to augment the information described, as a matter of design decision for an embodiment, without departing from the core of the present invention.

Family members table 240 contains records for members of a family, with key field “FMID”, “member of” relationship 242 established by foreign key “FamID”, and stores a description of each family member including name, nickname, gender, role (e.g., parent, child, uncle, etc.), birthday, ethnicity, nationality, languages spoken, status, and contact information. Status may be used to indicate whether the family member is generally present, away at college, stationed overseas, on a business trip, or even whether the family member is deceased. Such information allows media segments to be personalized to make reference to family members in a way that is consistent with a child's reality: Rather than presenting a generic dad in a generic family, a media segment can be selected and personalized to include the child's dad in a context compatible with the child's reality as represented by the status field in the record for the child's dad. If no family member record for a child's dad is present, then media segments including a non-generic “dad” reference would be avoided.

Since customizing and personalizing a presentation for a child is the thrust of this invention, a much more elaborate record is maintained for each child in children table 250, having key field “CID” and foreign key “FMID” forming “is a” relationship 254, since in each family in the system, at least one family member is a child. Note here that the crow's-foot notation for relationship 254 asserts that each child record in table 250 is associated with exactly one family member record in table 240, but that each family member record in table 240 may or may not be associated with a child record in table 250, because a family member (e.g., a parent) might not be a child, but a child is always a family member.

Each record in children table 250 provides a summary of a child's performance and achievements within the system, and may contain specific, frequently referenced facts about the child, as represented, for example, by “preferences”, “school name”, and “teacher name” fields. The “literacy level” and “math level” fields might initially be populated with an estimate based on the child's age, but in the course of interacting with the system, in particular media segments exercising those skills, the skill levels can be measured. Similarly, the “trouble letters”, “trouble words”, “trouble numbers”, “trouble operations” fields record information to allow personalization of segments designed to bolster skills in those areas.

The system may allow each child to select or design an avatar, i.e., a cartoon representation of the child used within the system, for example within interactive segments. The avatar would be stored in the “avatar definition” field of children table 250.

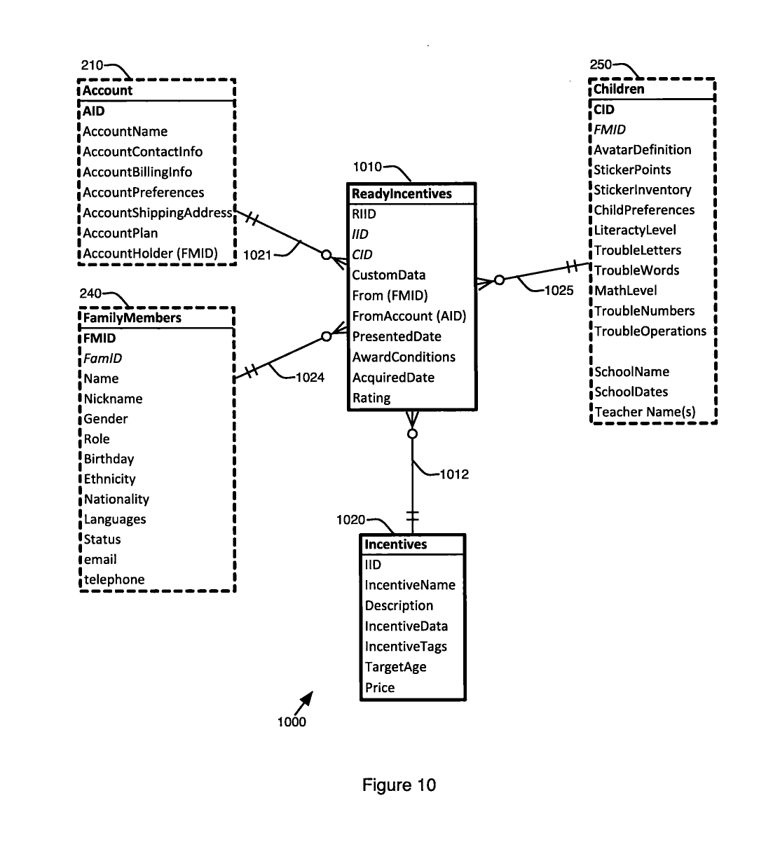

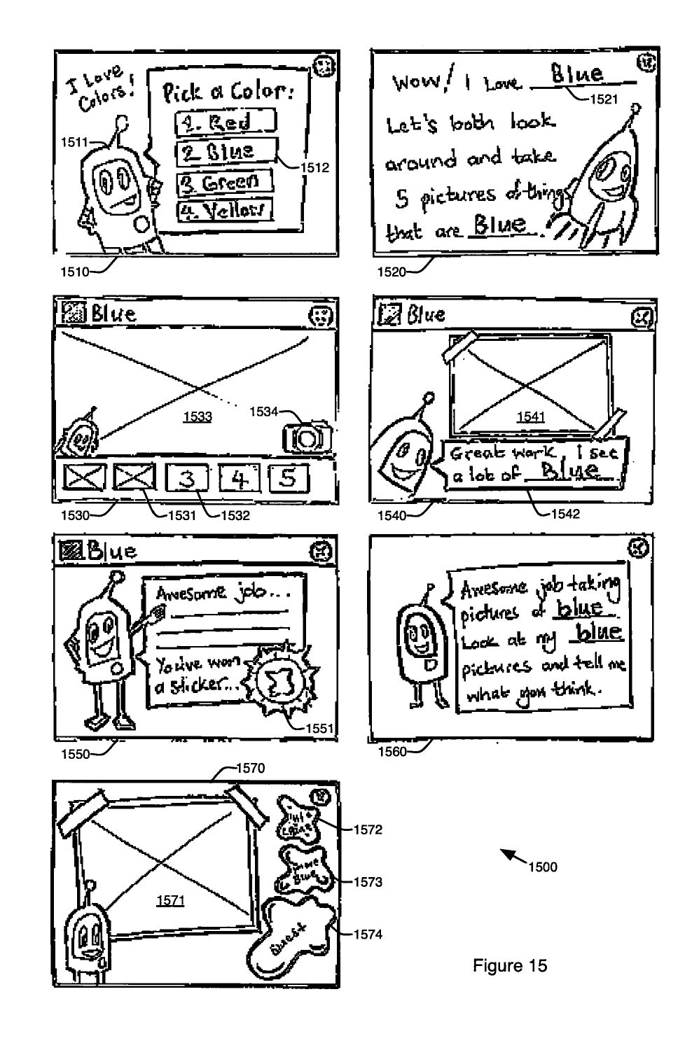

Certain achievements a child may make within the system can be rewarded with points to be accumulated, for example in the “sticker points” field. Such points may be redeemed for virtual stickers of the child's selection, which may be collected within the child's “sticker inventory” field. Additionally, some activities may award stickers directly (as shown in FIG. 15). Other incentives (as discussed below in conjunction with FIG. 10) may be recorded, too.

Facts about each family member, including children, can be stored in family member facts table 260. Uniquely identified by key field “FMFID”, each fact record is “about” 264 exactly one family member (via the “FMID” field) and has a type field containing foreign key “cFactID” creating “kind” relationship 276 with a particular fact type.

Herein, tables containing predefined, but extensible, canonical lists are prefixed with a “c”, and are used rather than an alternative embodiment of free-form information. Fact types table 270 is an example of this, where the fact name (e.g., “height”) has a description (e.g., “height in cm”), and a value type (e.g., integer). In this way, facts about each family member are captured in a specifically defined way that makes them easily comparable, and usable in expected ways. For example, a media segment may assert that a child's sibling is taller than the child, or that the child is taller than the sibling. By ensuring that the child's height and sibling's height are both available, and recorded in a common format, the media segment may be selected (i.e., customized) and personalized to represent actual facts about the child's and sibling's heights. Thus, if the fact value for height in table 260 associated with the child is “100” (i.e., 100 cm) and the fact value for height associated with the sibling is “70”, then the child is taller than the sibling, assuming that the fact date for each record is relatively recent. Part of the function of the episode server 130 is to periodically examine the records in family member facts table 260 and flag needed updates, depending on the associated fact type and other information, determine whether the fact date suggests the fact value is getting stale, or put another way, to what degree the fact value is likely to depart from the actual fact. For example, for a family member who is five years old, as determined by comparing the birthday in table 240 with the clock 132, height would be expected to have changed substantially if the fact date in table 260 is a year old, or even six months. Thus, every half year or so, a parent might be prompted by the dashboard app 161, when it determines an update is needed, to supply a new height measurement for the child. Conversely, for a family member whose height was reported when twenty-five years old, the height might be expected to change little over the next twenty years and thus the dashboard app 161 would rarely suggest an update to the height of older family members. Alternatively, updates to such facts may be scheduled, e.g., height measurement updates might be requested on or about a family member's birthday.

In some embodiments, or for some facts, an update may represent a new fact, with the most recent fact of a kind being the “current” one. Thus, all the records of a child's height might be retained for use in a media segment discussing growth and making reference to how the child's height has changed over time. This also allows entry of facts with fact dates other than “now”, for example, markings kept on the bedroom closet wall of the child's height at each birthday can be measured and entered along with their date. If “Hair Color” is a canonical fact type in table 270 with a value type of the enumeration {black, yellow, brown, red, white, gray, blue, green, purple, pink} and mom has dyed her hair red today, the fact that she was previously a brunette (fact value=“brown”) may still be retained in the original record about mom's hair color in family member facts 260.

In some embodiments, a child may have a playmate that, though not technically a family member, might be listed in family members table 240 with an appropriate role (e.g., ‘friend’). Role, may be selected from a canonical list as is fact type (i.e., by the “type” field in table 260), however the corresponding role type table with a key of ‘cRoleID’ to which ‘role’ in table 240 might refer as a foreign key is not shown.

Another way a playmate may be referenced, if the playmate's family is registered with the system, is to mark the two families as being friends, using the records in friend-families table 230, in which an initial proposal by one parent (e.g., using dashboard app 161) that the families become linked as friends produces a new record with key ‘FriendsID’, having the ‘from’ field contain the proposing family's FamID to form ‘friends’ relationship 232 and the ‘to’ field contain the target family's FamID to form friends relationship 233. When a parent of the target family next uses dashboard app 161, the proposed ‘friends’ relationship can be confirmed, the confirmation being stored in the confirmed field of table 230, at which point the friendship between the two families may be considered for use when generating episodes. In this embodiment, children in one family may be effectively considered as friends of the near-aged children (or other policy-selected criteria) in the friend families, if any.

Though listing a friend as a family member with the role “friend” can, in many ways, be treated the same friend extrapolated from a record in friend-families table 230, the latter mechanism provides the opportunity for added benefits. For example, if two like-aged children are registered with the system and listed as friends through a relationship such as the one provided by table 230, episode server 130 may provide both children with a shared episode or media segment at about the same time, so that they have a common experience (the episode) that they can discuss. Another opportunity might be if one child were to be expecting a new sibling and receiving episodes or media segments selected because of that fact, episode server 130 may provide media segments related to a friend expecting a new sibling. Similarly, children in a family observing a first religion might receive media segments related to having friends observing a different religion.

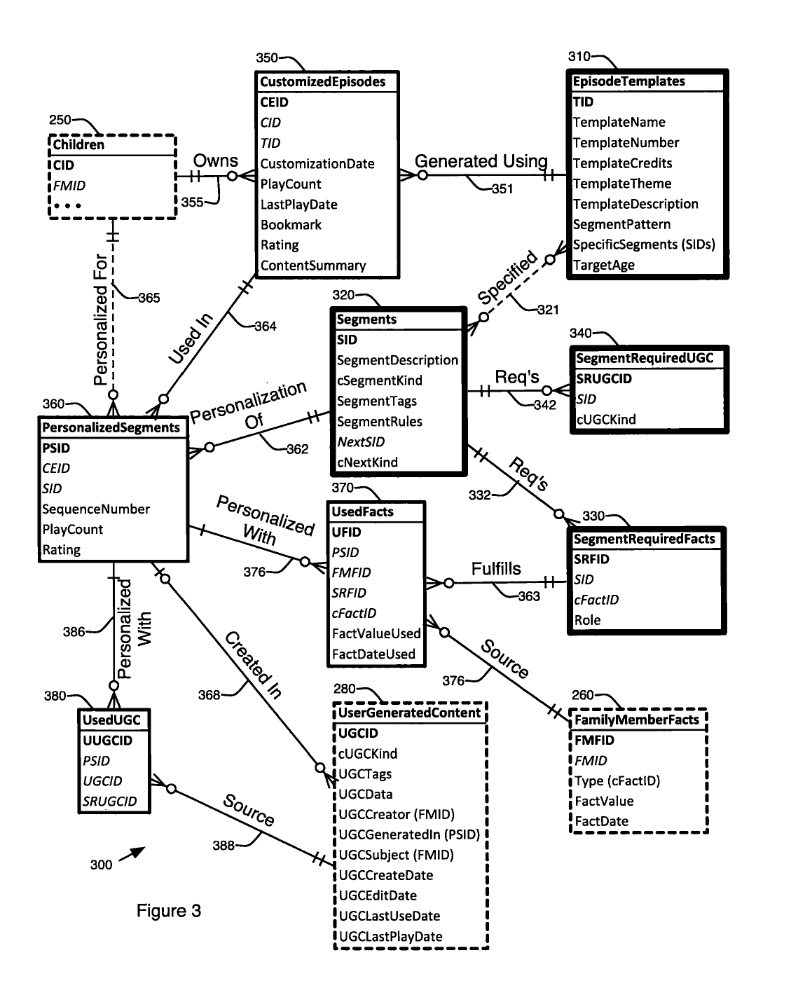

One of the activities supported in the dashboard application 161, besides adding family member facts into table 260, is providing user generated content such as pictures or voice recordings. User generated content table 280 is where such information is stored. Note that the acronym “UGC” is used throughout as an abbreviation for “user generated content”, including within field names. Uniquely identified by key field “UGCID”, each UGC record includes the content itself in field “UGCData”, along with metadata describing the content such as “UGCKind” which may be a canonical enumeration (not shown) indicating that content is a portrait image of a family member, a group photo, a location photo, an object photo, a greeting recording of a family member, a laughter or sound effect recording of a family member, a recording of a family member's name being spoken, etc. Depending on the content kind, the family member creating the content may be listed (e.g., the parent taking the picture being recorded in the “UGCCreator” field to create ‘by’ relationship 284), the family member who is the subject of the content (i.e., the speaker, or the photographic subject) in the “UGCSubject” field to create ‘about’ relationship 285. For group photos or photos of objects or environments, additional information may be entered into “UGCTags” field, or in an alternative embodiment, a plurality of canonical tags may be associated with each piece of content, as family member facts in table 260 were associated with family members in table 240. In some cases, user generated content in table 280 is generated by the child during the performance of an episode through player application 111. In such a case, the “UGCGeneratedIn” field may be populated with a foreign key identifier of the personalized segment in which it was generated (discussed below in greater detail in conjunction with FIG. 3). Other information such as the creation date, editing date, date the content was last used (i.e., incorporated into an episode), and the date the content was last played (i.e., the most recent date on which an episode in which this content appears was played), which can be used by the episode server 130 and/or dashboard application 161 to determine such things as which user generated content is being heavily used (e.g., if there is only one picture of dad, but that picture is being used a lot, additional pictures of dad might be warranted, for variety), which content is getting old (e.g., a picture of a child that is more than a year old may be getting too old and a new one should be supplied), or which content needs to be refreshed (e.g., when mom's hair color changed to red, previous portraits may be considered out of date). When user generated content is out of date, the parent can be prompted in the dashboard app 161 (or the child can be prompted in player app 111) to update the content. Some user-generated content generated by the child (as recorded in field “UGCCreator”) may be audited and perhaps edited by a parent in the dashboard app 161. For example, the child might take a photograph of mom, but in dashboard app 161, the parent might adjust the cropping of the image to make a better portrait. Also, the parent may confirm that the image is actually of the subject identified by the child. For example, if the child was tasked in player app 111 to capture a picture of the dog, the parent may confirm that the resulting image was, in fact, a picture of the named pet.

Pets, too, can be family members with a record in table 240 having the role field set to “pet”, for which there is an associated family member fact about the pet. The fact might be of type “species” and might have value “dog”. The process of entering a family member with the role of “pet” may require entry of an associated family member fact specifying the species.

In an alternative embodiment, pets could be represented in a separate table of pet records (not shown) associated with a family. However, the addition of specialized tables may introduce unnecessary complexity when family data 200 is being analyzed by episode server 130 while customizing new episodes for a child. Decisions such as this should be carefully considered by a database architect or application designer when building a different embodiment.

FIG. 3 shows a detailed schema of episode data 300. Note here that some tables of family data 200 are shown, namely children, family member facts, and user generated content tables 250, 260, and 280, respectively. These tables are shown in dashed outline and are not a part of episode data 300, but have relationships with episode data 300.

Episode data 300 comprises episode templates table 310, segment table 320, segment required facts table 330, and segment required user generated content 340, all of which represent data records not personalized to any child. Episode data 300 further comprises customized episodes table 350, personalized segments table 360, used facts table 370, and used UGC table 380 each of which store customizations or personalizations made for a specific child.

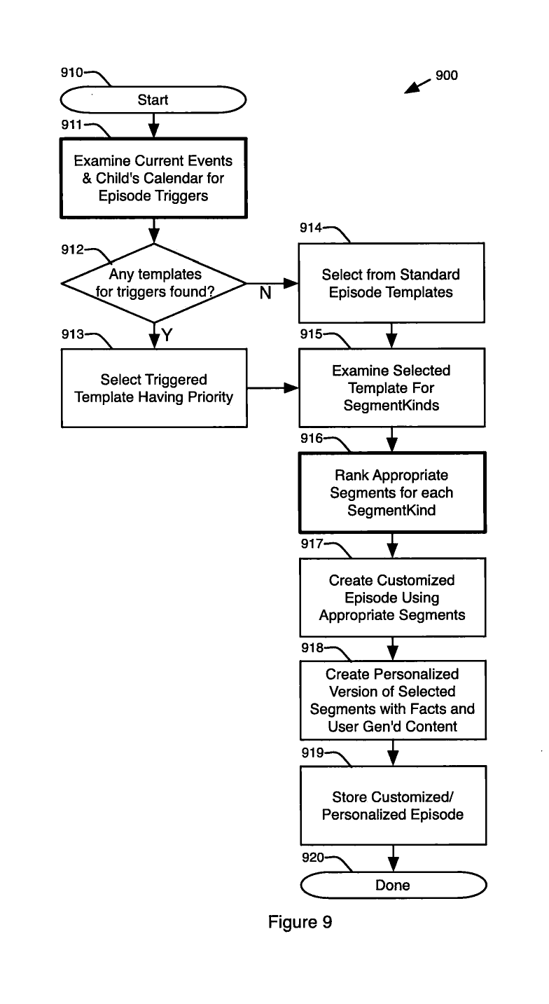

Each record in episode template table 310 describes an episode template, as might be created by educators or entertainment producers. The episode template establishes the mix and/or sequence of content types to be presented in an episode, and the pacing of the segments. The episode template is designed to capture a child's attention and retain their interest, but still to provide the educational and developmental stimulus desired. Uniquely identified by the key field “TID”, other fields may include such metadata as the template's name, number, authoring credits, theme (e.g., normal, holiday, special event, etc.), description, and target age. The definition of the episode template is stored in the “SegmentPattern” field, which lists the types of media segments to be used in creation of the segments. Generally, the sequence and approximate duration of these media segments is also suggested. In some cases, e.g., for a holiday episode template, there may be specific media segments that are called for by the template. These may be identified in the “Specific Segments” field by a foreign key “SID”, discussed next, and forms “specified” relationship 321. The process of using an episode template from table 310 to create a finished episode is discussed in greater detail below, in conjunction with FIGS. 8 and 9.

All available media segments are listed in segment table 320, for which key field “SID” uniquely identifies each media segment. Each record of segment table 320 contains metadata including a description or production title in the “SegmentDescription” field, and a canonical segment kind in field “cSegmentKind”. In one embodiment, canonical segments kinds may include social/emotional development, physical development, educational, or narrative, each segment kind being further subdivided into kinds that are linear or interactive. Educational segment kinds may be still further subdivided into kinds for literacy and mathematics, for example. These same kinds would be used to call out the primary specification (the “segment pattern”) of an episode template within the “SegmentPattern” field of records in episode templates table 310 and serve as one basis for selecting a media segment to be used at a particular place in the episode template.

Additional metadata included in records of the segments table 320 are the “SegmentTags” and “SegmentRules” fields. SegmentTags and SegmentRules may be used to further refine whether a media segment is appropriate to a child or event, or to allow a more explicit callout within a SegmentPattern.

Segment tags may be implemented as a list of name=value pairs common in XML, e.g., “HOLIDAY=CHRISTMAS”, but in another embodiment could be implemented with a mechanism similar to the one discussed above for family member facts. Both implementations allow extensible tag types without requiring a restructuring of the database, though other mechanisms could be used. For example, within the segment pattern for a holiday themed episode template, a call out for segment kind “NARRATIVE-INTERACTIVE” might further bear the tag restriction “HOLIDAY=TRUE”, in which case, only media segments having a cSegmentKind indicating they are narrative and interactive, might be selected, further subject to the restriction that a holiday tag is required.

Segment rules can express more complex restrictions, and could be expressed in a functional notation, e.g., “IN_RANGE(CHILD_AGE, 2, 5)” to indicate that the child's age must be from two to five years old for this media segment to be appropriate; or “EQUALS(CHILD_GENDER, MALE)” when a segment is mainly appropriate for boys; or “UNIQUE( )” if a segment should never be presented to the same child in more than one episode. The restrictions expressed in such rules may require a fair degree of computation to ensure compliance, whereas the restrictions expressed in segment tags are relatively simple to compute. For this reason, an embodiment may defer examination of the segment rules until after a media segment is first qualified under the segments tags, thereby allowing a degree of optimization. Note that either of the SegmentTags and SegmentRules fields can contain zero or more tags and rules, respectively.

In some cases, one media segment may have a specific presentational relationship with another segment, or several media segments might form a chain to be shown within a single episode (e.g., an unfolding story, or a running joke). For example, one segment might introduce a problem, while another segment provides an answer. To manage such presentational requirements, the “NextSID” field contains the foreign key for the “SID” of the next media segment in a chain. Note that this is generally not the next media segment to be presented, but one that must be presented before the end of the episode, perhaps with some additional restrictions. The “cNextKind” field may be used to express such additional restrictions which might take the form of “within 30 seconds” (indicating the next media segment in the chain must play within thirty seconds after the present media segment plays), “two intervening segments” (indicating that the next media segment should be the third segment after this one), “final” (indicating the next media segment should come at the end of the program), etc. In this or other embodiments, the “cNextKind” field allows the media segment author to note an artistic/creative structure larger than the media segment itself, and to do so in a way that allows the episode server 130 to respect that structure when assembling an episode from an episode template.

In the embodiment shown, the media assets associated with each media segment listed in segments table 320 are not stored within segment table 320, but are instead stored as shown in FIG. 4.

FIG. 4 shows Assets table 400, and segment data 410 comprising activities table 420 and summaries table 430, which store presentable media assets of various kinds associated with each media segment.

Each record in assets table 400, uniquely identified by key field “AssetID”, contains “AssetData” which may be a video (e.g., an MPEG movie file), picture (a JPEG image file), or interactive game (e.g., an application or Flash program file) or other linear or interactive multimedia presentation, or external reference thereto. The “cAssetKind” field is a canonical asset kind, which allows an easy determination of the asset type (e.g., a game program vs. a movie file). Additional metadata, not shown, may include the runtime for a piece of linear media, or an estimated play time for an interactive piece. The foreign key “SID” forms the “has asset” relationship 402, which links each record in segments table 320 to exactly one corresponding record in assets table 400. Note that assets table 400 is an embodiment of segment asset cache 400 with which segment server 150 is in communication as illustrated in FIG. 1.

Each record in activities table 420, represents an activity that a parent may undertake together with a child, or that the child or parent might undertake individually. For example, a narrative-linear media segment in table 320 about paper airplanes would correspond to a video asset (via relationship 402) in table 400, which might be included in an episode provided to the child through child's station 110 by episode server 130. Episode server 130 can then provide a paper airplane making and flying activity to the parent (e.g., through parent's station 160) and/or the child. The parent and child then have the opportunity to perform the activity together, where the child will be familiar with the activity, having just seen it in the current episode. Each activity record has key field “ActivityID”, a foreign key field “SID” that forms “has activity” relationship 422 with associated records in segments table 320, the data necessary to present the activity in the “ActivityData” field, and metadata illustrated by the “cActivityKind” and “cActivityRole” fields.

The “cActivityKind” field is a canonical identification of the kind of activity embodied in the activity data, for which examples in one embodiment are “SHARED PROJECT” as might apply to the paper airplane making activity, “QUESTIONNAIRE” as might apply to a set of questions to be answered by the parent (e.g., favorite color, favorite animal, in association with a segment on ‘favorites’), “READING” as might apply to a story to be read to the child, “CREATE USER GENERATED CONTENT” as might apply to a photography task to be completed by the parent, “CONVERSATION” as might apply to a topic or questions to be discussed during dinner.

The “cActivityRole” field is a canonical identification of the person(s) to whom the activity might be sent. For example, a photography assignment might often be assigned to a parent, but in some cases might be assigned to an older sibling (e.g., taking a photo of dad sleeping), or to a grandparent, or teacher.

Still a third kind of media asset that may be associated with a media segment is a summary, shown stored in summaries table 430. A summary is intended to provide a brief (e.g., one sentence or single bullet point) overview of a media segment in the current (e.g., today's) episode. The episode server 130 can provide a report summarizing the current episode to the parent through the dashboard app 161 by collecting the summaries for each segment in the episode. Note that not all media segments are significant enough to warrant a summary, nor will all summaries of segments in an episode necessarily be reported. Each summary record in summaries table 430 is uniquely identified by key field “SummaryID”, and has foreign key field “SID” to form “has summary” relationship 432 with associated records in segments table 320. Data representing the summary is stored in the “SummaryData” field. Other metadata, e.g., an “importance” field (not shown), might be included for use when consolidating multiple summaries from an episode (or multiple episodes) into a report for the dashboard app 161. Such summaries and the reports they populate are an important way to keep a parent abreast of the topics and experiences the child is receiving in the episodes.

In an alternative embodiment, the media assets could be stored in segment table 320, but generally, the large size of each individual media asset suggests that an optimized implementation may store them elsewhere (as shown).

Returning to FIG. 3 again, each segment may have zero or more requirements for certain family member facts (to be in table 260) or certain user generated content (to be in table 280). If such required information is not available, then the segment cannot be considered for inclusion in an episode.

Required family member facts are identified in segment required facts table 330, in which required facts are uniquely identified by key field “SRFID” and form “requires” relationship 332 to segments table 320 with foreign key field “SID”. The kind of family member fact needed is specified in the “cFactID” field, which would be required to match the “cFactID” field of a record in the family member facts table 260 corresponding to a family member. Further, the “role” field in table 330 specifies that the corresponding family member record in table 240 must also match. If a segment requires dad's hair color in order to be presented, the name “dad's hair color” might appear in the “fact name” field, and “cFactID” would correspond to the canonical fact type “Hair Color” (as discussed above in conjunction with FIG. 2) and “Role” would indicate that the family member must be “dad”.

Similarly, required user generated content is identified in segment required UGC table 340, in which required UGC are uniquely identified by key field “SRUGCID”, and form “requires” relationship 342 to segments table 320 with foreign key field “SID”. The kind of user generated content is specified in the “cUGCKind” field, which would be required to match the “cUGCKind” field in a record in the user generated content table 280 created by a family member. Additional fields (not shown) might specify the role of the family member who is the subject (e.g., to require a picture of dad), or might specify the creator (e.g., to require a picture taken by the child), or to specify a specific tag (e.g., to require a picture of the family kitchen).

In another embodiment, requirements such as expressed in tables 330 and 340 can be unique. For example, there might be only one required fact record for “dad's hair color” in table 330, and that required fact might be associated with all segments requiring that fact. So rather than “requires” relationship 332 being many-to-one as illustrated in FIG. 3, the “requires” relationship might be many-to-many (not shown, and requiring a linking table rather than the foreign key field “SID” in table 330). This has the advantage of making it easy to determine how many segments might be enabled by providing a certain family member fact, which then may be used to prioritize requests for family member facts or likewise with table 340, user generated content.

So, together, the episode templates in table 310, and the media segments and related data in tables 320, 330, 340, 400, 420, 430, represent a collection of generic content from which a customized selection may be made and indicates which and how segments may be personalized.

The editor module 810, shown in FIG. 8, populates the remaining tables 350, 360, 370, and 380 as it performs the customization and personalization process that prepares an episode for an individual child.

Customized episode table 350 contains metadata for an episode prepared for the particular child identified by the “owns” relationship 355 formed by the “CID” foreign key field in the records of table 350. The episode template used as the basis for the customized episode is identified by the “generated using” relationship 351 formed by the “TID” foreign key field. The date when the episode was customized is noted in the “customization date” field. The “content summary” field may be populated by combining the summary assets in table 430 that correspond to the selected segments (as previously described) and other information such as the “template theme” or “template description” fields of corresponding episode template.

The remaining fields for a customized episode record in table 350 are updated by the player module 1110 shown in FIG. 11 as the customized episode is played. For instance, the player module 1110 increments “play count” and updates “last play date” field, each time a customized episode in table 350 is played. The “Bookmark” field can be updated whenever the player module pauses the current playout. In an interactive segment, the “bookmark” field may further represent a saved game or the like. Lastly, the “rating” field may be an explicit response by a child to a direct question about how well an episode was liked, or the rating may be populated by noting the child's attention and emotional responses during the presentation of the episode by using facial recognition techniques with sensors 114 comprising a child-facing camera.

The specific segments selected by the editor module 810 for inclusion in a customized episode are recorded in personalized segments table 360. The first segment selected for inclusion is noted by having a “sequence number” field set to one, while consecutive segments have this field incremented. Note that this makes the sequence number field an index into the segment pattern of the episode template after which the episode is patterned. Each record in personalized segments table 360 has a unique key field “PSID”, the foreign key “CEID” to provide “used in” relationship 364 thereby belonging to the customized episode, and the foreign key “SID” to provide the “personalization of” relationship 362 thereby providing access to the assets of the generic segment.

As in the customized episode records of table 350, the “play count” and “rating” fields of table 360 are updated by the player module 1110 whenever the personalized segment is played.

In an alternative embodiment, a foreign key “CID” (not shown) provides “personalized for” relationship 365, which associates each personalized segment in table 360 with a child. In this alternative embodiment, “used in” relationship 364, rather than many-to-one as shown, is implemented as a many-to-many relationship (linking table or similar technique not shown), wherein the same personalized segment may be used in multiple customized episodes. In this embodiment, a personalized segment may appear in many different customized episodes for a child (e.g., if it is determined to be a favorite) and the play count and rating will be kept in one place (rather than spread across many instance of the personalized segment as it is constructed for use in different customized episodes).

As a segment is personalized and recorded in table 360, the family member facts or user generated content with which the segment is personalized is noted by “personalized with” relationships 376 and 386 formed by foreign keys “PSID” in each of tables 370 and 380, respectively. A record in used facts table 370 notes a family member fact with “source” relationship 376 formed by foreign key “FMFID”, the segment required fact being met is noted by “fulfills” relationship 363 formed by foreign key “SRFID”. A record in used UGC table 380 notes user generated content with “source” relationship 388 formed by foreign key “UGCID” and “fulfills” relationship (not shown) to table 340 with foreign key “SRUGCID”.

In the embodiment shown, used facts table 370 includes fields for “cFactID”, “fact value used”, and “fact date used”. This allows a personalized episode to retain the original personalization regardless of future changes in the underlying family member fact. If an implementation preserves original family member facts permanently, then these fields are not required. Similar fields would be required in used UGC table 380 to provide a similar long-term integrity if user generated content was not made permanent.

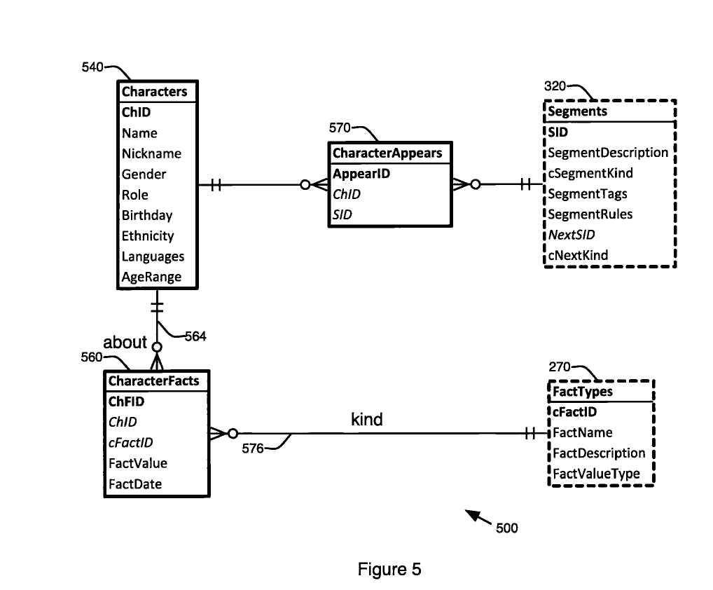

Characters, for example, as portrayed by actors or cartoon characters, or voices (e.g. a narrator), are common in children's programming. Some will be favorites, some not. Each is different and has different characteristics, which can be used in storytelling. FIG. 5 shows character data 500, comprising characters table 540 the fields of which strongly resemble those of family member table 240. Further, character facts table 560 strongly resembles the family member facts table 260, in both of which “cFactID” forms “kind” relationship 576 (276 in FIG. 2) though foreign key “ChID” forms “about” relationship 564. This similarity allows the character facts in table 560 and any media assets associated with the characters (none shown) to be substituted for missing family member facts to fulfill segment required facts in table 330 or for missing user generated content to fulfill segment required user generated content in table 340.

An example of this is seen when considering a media segment teaching relative sizes, in which the child is being compared to a larger family member, e.g., dad, and a smaller family member, e.g., baby brother. Family member facts required are 1) a parent having a larger height, and 2) a sibling having a smaller height. User generated content required are portraits of each. If the child has no smaller sibling, the editor module 810 might automatically substitute a character (e.g., a mouse) in table 540 that is associated with a character fact in table 560 giving a height smaller than the child's height. Additionally, media assets (not shown) related to the character would supply the required portrait for use in the presentation. The use of the character facts in table 560 and character related media assets (not shown) would be noted in tables 370 and 380 (with appropriate notation that the relationships are to character data 500, not family data 200), or in analogous tables (not shown).

Records in “character appears” table 570 note which characters appear in which generic segments, e.g., appearing in a way not subject to personalization. This table allows editor module 810 to customize the selection of segments in which a child's favorite characters appear, which might be determined by taking the ratings by a child of personalized segments in table 360 applied to the characters appearing in those segments from table 570 and performing a statistical dependence analysis. Characters with which high ratings have a strong dependence would be favorite characters, whereas characters with which low ratings have a strong dependence would not be favorites. Also, such ratings might be monitored vs. the customization date of the customized episode in which the personalized segment was used. This would be a way to quickly detect, as a child ages, a one-time favorite having been supplanted by a new favorite. Such a shift can be reported to a parent using dashboard app 161, to make them aware that a new favorite character is gaining popularity with their child. Such information might be exploited as a suggestion for dinnertime conversation, where the child is prompted to describe the new character to the parent.

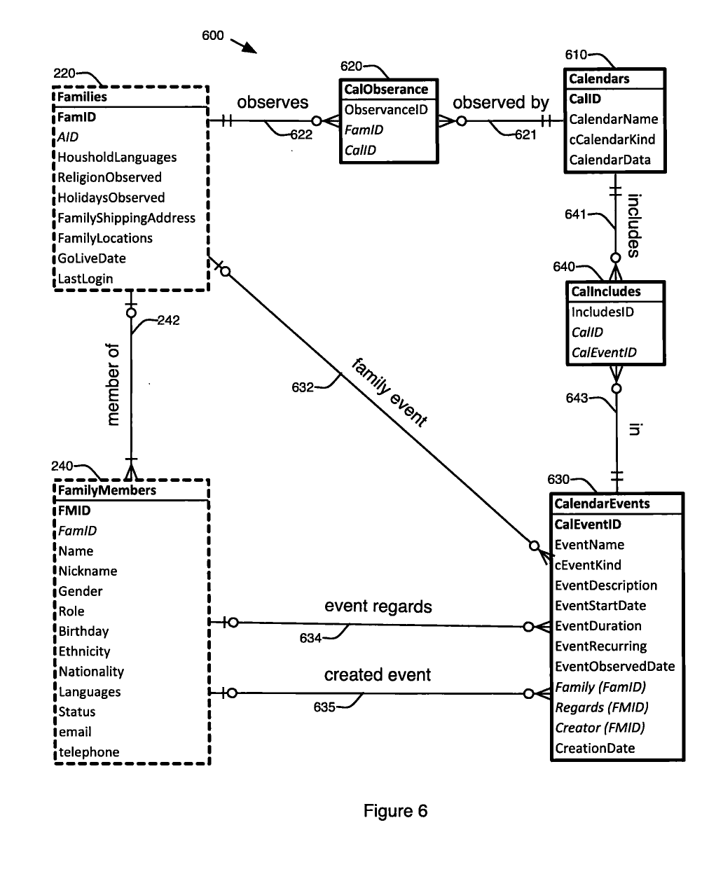

The seasons, school year, holidays, and family events such as birthdays and vacations can all be plotted on a calendar and events past, current, and future, used as the basis for customization and personalization of episodes and segments. Calendar data 600 shown in detail in FIG. 6, provides a way to conveniently collect calendar data where only special family events need to be entered . . . most of the other events recognized by a family can be automatically supplied based on family information 200.

Calendar table 610 contains a record for each calendar supported by system 100. Examples included in one embodiment are national holidays (by country), religions holidays (by religion and denomination), state holidays (by state), school holidays (by school district). For countries and families for which sports are extraordinarily popular, major sporting events calendars (e.g., noting dates for the World Cup, Superbowl, World Series games, etc.) might also be provided.

Which calendars a family observes are recorded in “calendar observance” table 620, in which each record forms both “observes” relationship 622 with foreign key “FamID” and “observed by” relationship 621 with foreign key “CalID” to create a many-to-many relationship allowing each family to observe zero or more calendars, and each calendar to be observed by an arbitrary number of families.

Each record in calendar events table 630 represents a particular event, for example a holiday. One record might indicate Christmas (the “event name” field) on December 25th (the “event start date”). A second record might indicate Christmas on January 7th (Orthodox Christians). A third record might indicate Christmas on January 6th (Armenian Church). Records in “calendar includes” table 640 may link each event with foreign key field “CalEventID” (forming “in” relationship 643) to a calendar with foreign key field “CalID” (forming “includes” relationship 641). Whereby any of the three event records can be associated with multiple calendars: The first record with most Christian calendars and those of many North and South American and European national and state governments, the second record with an Orthodox Christian religious calendar and the Russian national calendar, and the third with calendars of the Armenian Church.

The advantage of this arrangement is that a calendar of events assembled for a family from the calendars in table 610 which it observed (from table 620) can be constrained to list any calendar event record from table 630 at most once. Thus, rather than noting a Christmas holiday for every calendar including that holiday, the holiday is only listed once, perhaps with a notation as to which calendars contribute it. In cases where more than one of the three example Christmas events are included on a family calendar, e.g. for an Armenian family living in the state of California, the state and national (and perhaps school) holidays may occur on December 25th, but the religious holiday would occur on January 6th. The Russian/Orthodox Christian date of January 7th would not appear on their calendar.

Additionally, a family's personal events may be included as calendar event records in table 630. Such records would not be included in any calendars of table 610, i.e., no records in “calendar includes” table 640 would mention their “CalEventID”. For example, the birthdays of each family member would be represented in a record of table 630. The foreign key “FamID” in the “family” field would establish “family event” relationship 632 (“family” would be set to null in any calendar event record to be associated with “calendar includes” table 640. Some family event records in table 630 may also provide foreign key “Regards” to create “event regards” relationship 634 (e.g., whose birthday is it), and foreign key “creator” to provide “created event” relationship 635 (e.g., who added this event). The latter would normally be null for birthdays, since those events can be automatically inserted from the birthday field of records in family members table 240. However, if a calendar event record were to be created by mom for grandpa's upcoming visit, then mom would be the “creator”, grandpa would be the “regards”.

In one embodiment, a canonical list for the field “cEventKind” might comprise “holiday”, “vacation”, “visit” (for someone coming), “trip” (for going to visit someone or somewhere else), “game” (for sports), “school” (for plays, recitals, etc.), “birthday”, “due date” (for expectant families), “moving” (for a family about to relocate), “homecoming” (for returning servicemen), etc. A list of canonical values has the advantage rules or policies within the editor module can be more easily established for customizing episodes or personalizing segments.

The “event name” and “event description” fields are self-descriptive, as are “event start date” and “event duration”. The “event recurring” field can designate a repeating event (e.g., Tuesday bowling, or annual events having a consistent date), so that they don't need to be re-entered continuously. The “event observed date” may be used for events (e.g., Christmas) that occurs on a particular day, but because that day is already a non-work day (e.g., a weekend), the observance occurs on a different day (e.g., the Friday before or the Monday after).

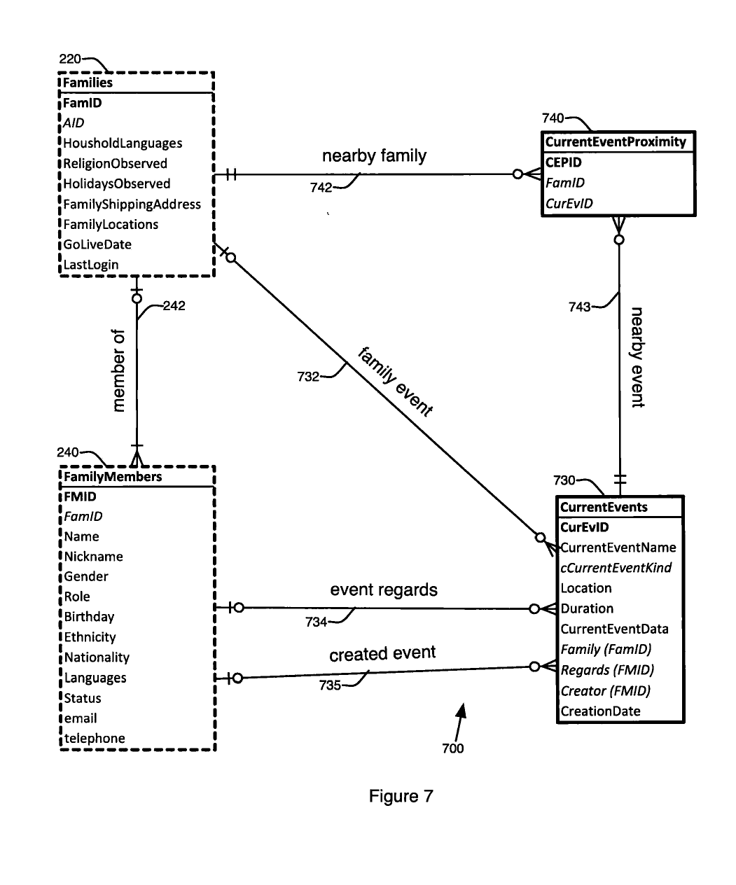

Somewhat similar to calendar events are current events. FIG. 7 shows details of one embodiment of current events data 700, in which records in current event table 730 may be associated with families in the vicinity of the event. Current event proximity table 740 contains records having both “nearby family” relationship 742 and “nearby event” relationship 743 based on foreign keys “FamID” and “CurEvID”, respectively. Each record in current events table 730 has a unique key “CurEvID”, and may be described in the “current event name” and “cCurrentEventKind” fields, the latter being analogous to “cEventKind”, but with canonical values representing current events, such as “weather”, “civic celebration”, “astronomical”, and other events have a locality (as represented in field “Location”). If an event is expected to last more that a day, the “Duration” field can be used to represent this. Data further describing the event can be included as tags or descriptive information as needed for presentation in the “current event data field”. Examples for an event kind of “weather” include “first snow”, “blizzard”, “rain”, “flood”, etc.; for “civic celebration” examples include “4th of July fireworks”, “county fair”, etc.; for “astronomical” examples include “solar eclipse”, and “aurora borealis”.

An activity that episode server 130 can perform in the background is to accept or research current event information, for example from administrators entering data manually, or by automatically searching for information available through Internet 120 on remote data servers (not shown), e.g., a weather data service. In this way, current weather events can be identified as having some locality, e.g., by state, county, zip code, geocode (i.e., latitude-longitude pair), or the like. An extent might also be provided within the “location” field, allowing a single weather event report to cover very large regions.

A family's location, as represented in families table 220, is stored in the address and “family locations” fields. Thus, a current event may be identified as corresponding to the family home, but information about grandma's events might also be available.

Family members may be allowed to enter current events into table 730, with the analogous “regards”, “creator”, and “family” fields creating the analogous “family event” 732, “event regards” 734, and “created event” 735 relationships as in FIG. 6. Non-family events would have a null “family” value.

Family events can also be promoted to non-family events (e.g., the example civic events) when more than one family provides a substantially similar event (with more families providing similar events corresponding to corroboration), the event may be automatically promoted to a non-family event. For example, if a dozen families in a region provide a “civic celebration” event related to “fireworks” at the same zip code or street address, then episode server 130 may reasonably accept that as corroboration of such an event. In another embodiment, such events may be accepted from “trusted” sources (e.g., long-time account holders) without the need for corroboration.

Current events in table 730 may be used in customization and personalization by editor module 810 in the same ways as calendar events in table 630.

FIG. 8 shows editor data flow 800, describing the operation of editor module 810. Editor module 810 has access to the collection of episode templates in episode templates table 310. From that collection of templates, editor module 810 must select a template currently appropriate to a child, e.g., episode template 820, stored in the “segment pattern” field of table 310. The selection is made on the basis of information about the episode template stored in the other fields of table 310 (e.g., target age) and information related to the child, (e.g., the child's current age), to ensure that an appropriate episode template is selected.

Episode template 820 comprises a series of media segment callouts, i.e., placeholders to be replaced by media segments. Example media segment callouts 821, 822, and 823 are provided in the “segment pattern” field of table 310. Each callout in the segment pattern specifies a canonical segment kind and may further specify an approximate duration or other constraint for a media segment to be selected to take the place of the callout. Specifying the individual segment durations in each callout provides a simple mechanism for regulating the overall length of the resulting episode to a predetermined duration. As shown graphically in FIG. 8 (and in tabular form in FIG. 3), segments table 320 is populated by many kinds of media segment, the eight shown are linear and interactive forms of social/emotional, physical, educational, and narrative categories. Additionally, segments for the introduction and end of the show may be included in segments table 320 or elsewhere (not shown).

Thus, in episode template 820, the media segment callout 821 is for a linear narrative segment (e.g., a story), media segment callout 822 is for an interactive physical segment (e.g., an exercise activity), and media segment callout 823 is for the end segment to close out the episode (e.g., the closing theme song and music video).

Once editor module 810 has selected episode template 820, additional customization is performed by selecting the individual media segments to take the positions of the media segment callouts. This will eventually result in a record for the newly customized episode being stored in customized episode table 350, with an “owns” relationship 355 with the child for whom the customization is made and “generated using” relationship 351 tying back to the source template. Further, a record for each selected media segment is added to personalized segments table 360 with the “used in” relationship 364, which effectively replaces the original media segment callouts with specific personalized media segments, e.g., 831, 832, and 833 that substantially meet the restrictions imposed by the episode template and the segments themselves. (Note that the title of the table 360, “personalized segments” does not strictly require that the entries be personalized, or personalizable. These records represent selected segments, which if they are personalizable, will be personalized by either the editor module 810 or player module 1110.)

In one embodiment, the actual selection of segments to take the position of each media segment callout can be treated as a constraint optimization problem. As previously described, segments represented in table 320 have tags and rules, some require certain positional relationships to other segments (i.e., those prescribed in the “NextSID” and “cNextKind” fields), and may have other requirements for facts or content specified in tables 330 and 340 (related to table 320, but not shown in FIG. 8). The requirements and rules can be evaluated against information 840 related to the child, that is, data that resides in the owning child record in table 250 (via relationship 355), or in records of other tables related thereto. Of all media segments available, only some will meet the requirements for a given callout for this child. In some cases, requirements for certain facts or content can be relaxed by substituting characters in place of family members, as previously described in conjunction with FIG. 5. From among all the segments having satisfied constraints for use in place of a particular callout, that is, for which the rules and requirements are met for this child in this situation, selecting the one to be used is an optimization problem.

Selection among those segments having satisfied constraints could be made randomly, or by picking a least-recently used segment (e.g., where segments take the “customization date” of the most recent customized episode in which a “personalization of” 362 the segment is “used in” 364), or other trivial algorithm, but the results will be marginal. A better selection can be made by taking information about the child (some of which may already have been used to satisfy the segments constraints), and compute a utility function with information about the segment as represented in the segment tags or usage information regarding the facts or content that can satisfy the segment's requirements. For example, if one segment requires a picture of dad as user generated content, and that picture has been used in episodes every day for the past week, that segment would have a lower utility value than another episode that requires user generated content which hasn't been used before. This aspect of the utility function would implement a goal of avoiding overuse of specific pieces of content.

As mentioned above, a computation can determine whether a character is a child's favorite or not. A utility function can favor segments using or able to use a favorite character. Such a positive bias toward a favorite character will work in opposition to the negative bias of avoiding overuse of specific pieces of content, in this case, characters or their associated media assets (not shown). This might result in a favorite character appearing two or three times per episode, while other characters would generally appear less often.

High utility value may be given to segments that may be personalized to bolster a child's skill with trouble letters, words, numbers, or mathematical operations, etc., as recorded in children table 250.

Utility value may consider other similar segments within the same or recent episodes. For example, if an physical segment involves a lot of jumping, as might be indicated by a segment tag that identifies “jumping” as an exercise (e.g., segment record in table 320 having a “segment tags” field containing the name value pair “EXERCISE=JUMPING”), then selection of that segment for inclusion in the episode would degrade the utility value for other segments having a similar tag: Too much jumping may be considered undesirable. The same kind of competition between segments sharing similar levels of exertion, even though the exercises are different can be used, too. In one embodiment, tags for exertion may take the form of “EXERCISE_LEVEL=HIGH”, or in another embodiment, and exertion point score, as in “EXERCISE_LEVEL=9”, such that an episode might be constrained to not exceed fifteen points of exertion.

The utility function may be overridden by the “NextSID” and “cNextKind” fields in segment table 320, which require certain intervals for subsequent segment presentation.

The utility function can also be subjected to an annealing process. For example, an early selection of a first physical segment with a tag “EXERCISE=JUMPING” might be reconsidered if a second segment selection forces a “NextSID” requirement directed at a third segment having an “EXERCISE=JUMPING” tag. In such a situation, both candidate selections (the first physical segment, and the second segment that forces selection of the third segment) may be explored for better likely utility function values as more of the episode segments are selected.

As the customization of the episode proceeds and selected segments are added as records in personalized segments table 360, the actual personalization of segments can proceed.

For each selected segment having any required facts or required UGC listed in tables 330 and 340, those requirements must have appropriate facts and/or UGC associated in “used facts” table 370 or “used UGC” table 380, as previously described in conjunction with FIG. 3. The selection of which user generated content or family member facts from among those meeting the requirements can be selected in much the same way as segments are selected: selecting randomly, picking the least-recently-used fact (e.g., as determined by the “UGCLastUseDate” or the like), or other trivial algorithm will work, but may achieve only marginally satisfactory results. A different utility function would provide better results, this one directed to the selection of user generated content and/or facts for personalizing the segments.

Another form of personalization uses data about the child's previous performance and skill levels, for example as summarized in the child's record in table 250. In an interactive segment, a difficulty level or response times or the like, may be set on the basis of such data. For example, in an interactive education segment directed at arithmetic drills, the child's “trouble operations” may be used to bias the drills towards operations with which the child has more trouble. The time allowed for a response might be set based on the “math level”. Even so, after a failed attempt at a troubled operation, the drill design in one embodiment might deliberately use operations not in the troubled operations set for the next question or two, so that the child experiences legitimate success immediately following the failed attempt.

Other personalization may be based on other data 840 related to the child. For example, the time of day at the child's location may be used to set the background in a segment (e.g., if it is nighttime, the sky in a scene might show stars and moon, but in the daytime, the sun.) Current events might affect the rendition, too: Noting stormy weather in the child's region may be used to make the sky in a scene cloudy).

In some embodiments, some personalizations, for example some of those based on trouble operations, arithmetic skill, the weather, or the time of day, or the like, can be performed by the editor module 810 as the new episode is constructed, or the personalization can be left open for resolution by the player module 1110 when the episode is playing. When to make such personalization is a design decision. If made when the episode is created, then the personalization may be frozen at that time, such that if an old episode is replayed, the math drills are directed toward the trouble operations and arithmetic skill of the child at that time. However, if these personalizations are left unbound until the episode is being played, then the math drills would be directed toward the presumably more advanced skills of the child (at least to the extent possible within the segment). This result is more desirable is a design decision.

Those skilled in the art will see from the foregoing that a utility functions used by editor module 810 can exploit the data 840 and 850 to make good selections for customization, and further to make good choices for personalization. While the computation of such utility functions can represent a substantial computational task, this is not an overriding concern because editor module 810 can build a customized episode in advance, and store it for later access by the child. It is not required for the editor module to run on-demand while a user is waiting. This relaxation of what would otherwise be a severe time constraint allows the utility function for the segment selection optimization performed by the editor module 810 to be arbitrarily complex. As more users burden the system, more episode servers 130 comprising more editor modules 810, can be applied to the task.

Another view of the editor module's operation is shown in FIG. 9, as a flowchart for customization and personalization process 900, which starts at 910 with the child for whom an episode is to be customized and personalized already selected, and records related to that child from database 140 available to the editor module 810.

In some embodiments, at 911, current events from table 730 and calendar events from table 630 associated with the child are examined to determine whether any events correspond thereto are triggers that induce or otherwise prefer the selection of one or more specific episode templates from table 310. For example, the “Christmas” calendar event might match data in the “template theme” or other tag or metadata fields (not shown) in one or more records of episode templates table 310. At 912, if events occurring today or tomorrow are found, and if at least one specific episode template can be associated with such events, then a trigger condition is detected, and processing continues at 913 wherein a template-selection utility function evaluates which of one of the templates so triggered has the highest value for presentation to the child, today. Once the template is selected, process 900 continues at 915. If no such triggering events are found at 912, or if the events found do not correspond with any specific episode template, then processing continues at 914.

For embodiments that do not provide triggers as described in blocks 911, 912, and 913, following start 910 processing advances directed to 914.

At 914, the list of episode templates in table 310 is examined to select a template for today's episode for the child. As described above, a utility function is a good mechanism for scoring each episode template in table 310, and the template having the highest score from the template-selection utility function is selected.

After the episode template is selected, whether influenced by a trigger at 913 or not at 914, at 915 the segment pattern of the episode template is examined for which segment kinds are needed, including additional restrictions on segment selection, if any (e.g., specific segments, segment durations).

At 916, a segment-selection utility function (or other selection mechanism) is applied to rank those segments of table 320 that a) correspond to each listed segment kind, b) meet the restrictions in the episode template, and c) for which the segment's own restrictions are satisfiable (e.g., for which required UGC and/or facts are available or substitutable using character-related data 500, or have next-segment requirements).

At 917, for each position in the segment pattern, a segment meeting the three requirements and ranked highest (or, in some embodiments, ranked higher than at least one other segment) is selected by the segment-selection utility function. Whether embodied in the segment-selection utility function or separately, a restriction may be to disallow any segment from appearing more than once in an episode.

At 918, each personalizable segment selected for inclusion in the episode is personalized with required user generated content, family member facts, character facts, and other data (e.g., current events such as the weather, the time of day, or the child's preferences, avatar, pertinent skill level, etc.). In a case where more than one choice is available for a particular personalization, a personalization utility function or other mechanism is used to select from among the valid choices.

In some embodiments, some personalizations may be left unbound, to be resolved by player module 1110 when the episode or each segment is about to be played.

At 919 the customized/personalized episode is stored for later presentation by player module 1110.

Process 900 concludes at 920.

In some embodiments, incentives for the child in addition to the “sticker points” mentioned in conjunction with the fields of children table 250 may be supported. An example of such additional incentive data 1000 is shown in FIG. 10, and may be considered to be an extension to account and family data 200.

In one embodiment of incentive data 1000, as shown, a catalog of possible incentives is provided by incentives table 1020. Each record in incentives table 1020 is uniquely identified by key field “IID”, and described in the “incentive name” and “description” fields. Other metadata fields may be included such as “incentive tags” and “target age”. In some cases, individual incentives might be actual merchandise that would be shipped to a parent for presentation to the child. For such “real” incentives, there may be an associated “price” field. To acquire such incentives, a parent would have to buy them, or in some embodiments, subscribe to some premium level “account plan”, or the like. For such incentives, the “incentive data” field might contain a SKU or part number, or other identifier suitable for a merchandise order system. Other incentives may be “virtual”, in which case, the “incentive data” field would contain a picture or other media representing the virtual item. Virtual incentives may or may not have an associated “price” to the parent.

When a parent places an order for an incentive for a child, e.g. using the dashboard application 161, a record is made in ready incentives table 1010, uniquely identified by key field “RIID”. Each ready incentive record uses foreign key field “IID” to form relationship 1012 with the corresponding incentive record, e.g., to provide access to the descriptions, tags, and incentive data. The foreign key field “CID” is used to link the incentive to a child via relationship 1025, while the “from account” foreign key (AID) associates the order with an account via relationship 1021 (e.g., for billing purposes). The foreign key “from” (FMID) links back to the family member acquiring the incentive for the child. The “custom data” field may be used by the parent to include a particular sentiment or special user generated content with the incentive. For example, a virtual stuffed animal might include custom data that is an audio file of barking, by the child's real-world dog. “Acquired date” may be used to keep track of physical merchandise that is shipped to a parent, which may initially be the expected delivery-by date, and is subsequently set to the actual delivery date. For each ready incentive, the parent can specify, or the dashboard application 161 may suggest, “award conditions” that specify under what circumstances the system should consider the child as having earned the incentive. An example of such a condition might be to eliminate “division” from the “trouble operations” list in the child's record, or to advance to the next “literacy level”.

As the player module 1110 presents episodes, it may detect that an incentive should be awarded, thereby causing the “acquired date” to be set. In some cases, award of the incentive may occur automatically (e.g., as with virtual incentives), but in cases of physical incentives, the parent is notified, e.g. via the dashboard application 161, or via another communication channel as suggested by the parent's contact information (i.e., email, phone number, etc.). The parent may, in turn, notify the system that the incentive has been awarded.

Some incentives may straddle the line between virtual and physical. For example, an incentive might be a printable certificate entitling the child to dinner at a pizza restaurant, or to picking tomorrow night's dinner. Such an incentive is virtual, in the sense that there is no physical shipment and the system can award it immediately upon it being earned, however the child then presents the certificate to the parent to be redeemed.

FIG. 11 shows a data flow diagram for the operation of the player module 1110. The customized episode 830, associated personalized segments from table 360 and used facts and content, and the segment assets 400 are accessed by player module 1110, and played out as customized, personalized experience 1120. The access to episode 830 and the related media assets may be directly from servers 130 and 150, or may be from episode/segment cache 112.

In one embodiment, experience 1120 is generally linear, like a television show, for which a time line 1121 runs from start to finish and a current position 1122 can be generally indicated. As with a television show that has been recorded, the child can advance or back up the current position 1122 to skip or replay an individual segment, part of a segment, or entire episode. Playout can be paused and resumed, and if paused between sessions, the current position 1122 can be stored in the “bookmark” field of the customized episode record in table 350. However, some segments are interactive, and while an approximate duration may be known or estimated, the actual duration of an interactive segment may vary. In such a case, current position 1122 may merely be within a segment, or may approximately represent the child's progress in the game. In such cases, the timeline 1121 is only approximate.

If during the assembly of episode 830, any of the required segment personalizations were left by editor module 810 to be resolved by player module 1110, the resolution takes place at least as the segment requiring personalization begins to play. Run-time information for experience 1120 may comprise final personalization data, for instance, the current time-of-day from clock 113, or current events (e.g., weather) from table 730. Other run-time information used during playout of a segment includes, for instance, input from real-time sensors 114, and ready incentives in table 1010 (for example, to track progress against the “award conditions”.

In this way, the player module 1110 presents a customized, personalized episode to the child. The episode might be the most recent episode produced by editor module 810, or it may be an older episode for which the necessary records still exist in customized episodes table 350, personalized segments table 360, and the other related records.

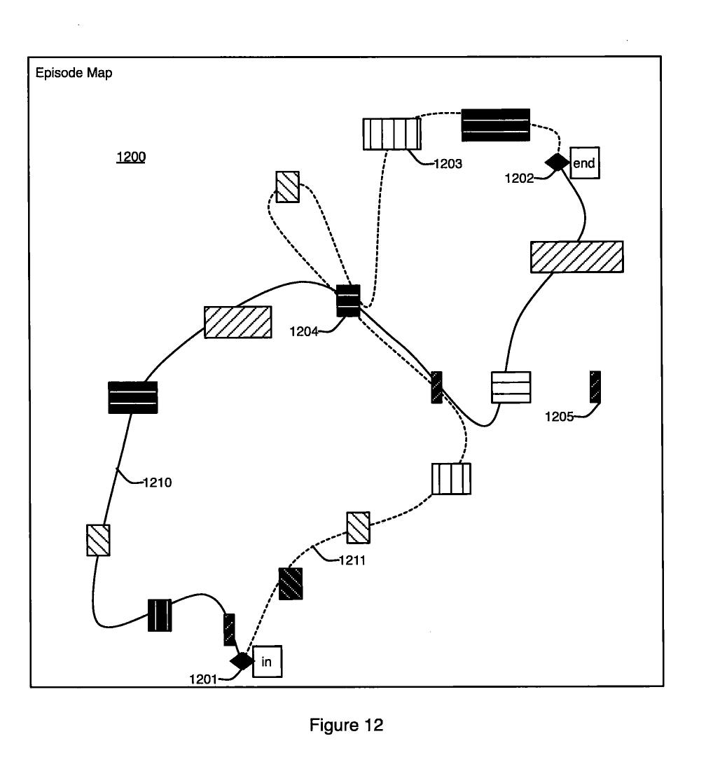

In another embodiment, shown in FIG. 12, instead of linear episode experience 1120, the presentation of the episode may be spread out over locations within a virtual world (i.e., a game world). The segments selected during customization are placed around episode map 1200, for example personalized segments 831 and 832 in customized episode 830 are shown as segments 1204 and 1203, respectively. The beginning and end of the episode are located at 1201 and 1202, respectively, that is, as the episode starts and the introduction plays, the child's position (in the game world) is at 1201. The child is free to choose a path through the world, visiting sites where segments are available to be experienced. One such path is solid line 1210, while a completely different path is dotted line 1211. Note that while path 1210 visits about half the segments one time before reaching the end 1202, path 1211 returns to segment 1204 for a second play. Both paths have not included segment 1205. Such free-form travel between and among segments takes the place of the skip forward and rewind behavior of the current position 1122 in the linear presentation of experience 1120. The map-based experience of an episode is better suited to older children sufficiently familiar with navigation within virtual worlds and games, whereas the linear experience is well suited to young children.

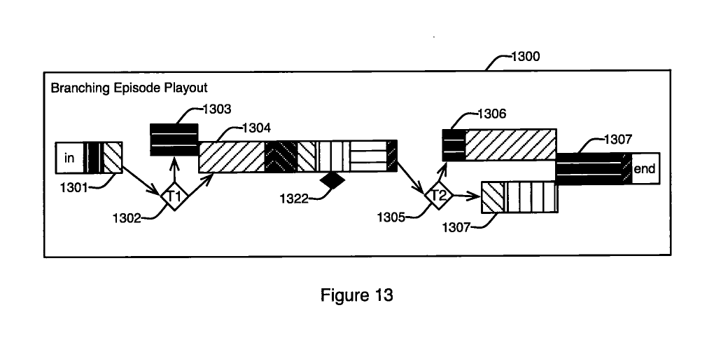

Still another form of presentation is shown in FIG. 13, where experience 1300 is a branching episode playout. Like the map-based experience, a child need not pass through every segment, and in one playout, perhaps cannot. The timeline of the branching episode playout (not explicitly shown) flows generally from left-to-right, beginning at the introduction (“in”) segment, and with current position 1322. Unlike the linear presentation of experience 1120, in the branching presentation of experience 1300, as segment 1301 concludes, a test “T1” is evaluated at 1302 with the result in one case that segment 1303 begins next, followed by segment 1304, or in the other case, segment 1303 is skipped and segment 1304 begins directly. An example of test “T1” might be whether a blizzard that was looming at the time the episode was created has actually arrived at the child's location at the time the episode is being played. If so, then the blizzard-related segment 1303 is shown, but if the blizzard hasn't yet materialized, the episode skips the blizzard-related segment.

Following the outcome of another test “T2” evaluated at 1305, either one sequence of segments beginning with 1306, or another sequence of segments beginning with 1307, is presented, both sequences leading to a common segment 1307. An example of test “T2” might be that at the time the episode was created, the child had earned an incentive and the parent had been notified, but at the time, the episode server 130 had not received confirmation from the parent that the incentive had been provided to the child. If at the time “T2” is evaluated the incentive (as an example, a plush character doll) has been presented, the sequence of segments beginning at 1306 can introduce the character. However, if there is no confirmation that the incentive has been presented, an alternative sequence of segments is played beginning at 1307. In this way, regardless of the result when “T2” is evaluated, the episode has approximately the same overall duration.

The branching episode model shown in FIG. 13 can be used as an alternative to postponing either or both of customization and personalization. Based on the tests such as 1302 and 1305, different segments are selected (changing customization as late as playout time), and by the mechanisms previously discussed, player module 1110 may provide final personalization as late as the start of an individual segment.

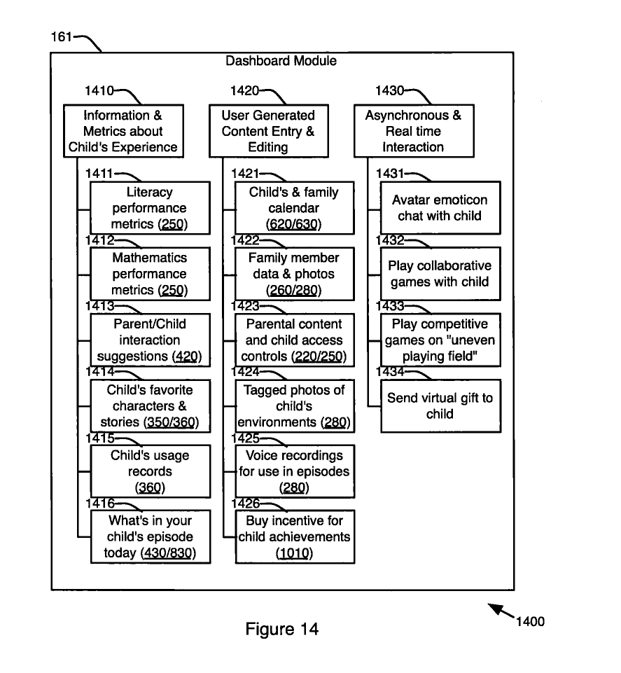

FIG. 14 is a summary menu for key functions provided to a parent by dashboard application 161. Exemplary categories 1410, 1420, and 1430 each include a number of functions for the parent.

The category “Information and metrics about the child's experience” 1410 includes reports 1411 and 1412 of the child's literary and mathematical performance metrics, for example showing recent scores and graphs of long term progress; current or recent suggestions for parent/child interactions 1413, which may further accept feedback from the parent as to which suggestions were taken and how they rated; introducing the parent to the child's favorite characters and stories 1414, e.g., so the parent can be less lost when the child is describing the various adventures of the characters; the child's usage records 1415, which can indicate how often and for how long the player application 111 is being used; and the summary report (the assembly of which was described above) of the child's current episode.

The key functions offered under the category of “User generated content entry and editing” 1420, includes selection and editing of the child's and family's calendars and events 1421; family member fact and user generated content entry and editing 1422 also can present requests made by the system for specific facts or UCG, e.g., for pictures of the child's grandparents, or pets, or the kitchen; parental content and child access controls 1423, for example to establish limits about what information might be presented to a child regarding other religions, other family types (e.g., single mom's, two dad's), etc.; tagging photos of the child's environments 1424, whether provided by the parent or taken by the child; voice recording for use in episodes 1425, e.g., mom's laugh, for use as a laugh track, or a sibling's voice, saying their own name for episodes in which family members identify themselves; buying incentives or noting the receipt or presentation of an incentive 1426.

The category of “Asynchronous and real-time interaction between the parent and child” 1430 includes these key features: A real-time animated chat 1431 with the child, requiring the parent and child to be using their respective stations 160 and 110 simultaneously, or to share the child's station 110, the chat using emoticons or avatars for children too young to type or read extensively; playing collaborative games with the child 1432, or playing competitively 1433, but with an “uneven playing field” so that the child and parent are a more-fair match for each other; and sending the child a virtual gift 1434, similar to an incentive or stickers, but without requiring any specific achievement.

FIG. 15 portrays an interactive segment 1500 of the present invention, as presented by player module 1110 on child's station 110. At 1510, the robot character 1511 proclaims a love for colors.

It may be that the robot character 1511 presents this segment because the robot was one of several characters which can present this segment, and of those characters, the robot is the child's favorite (representing a personalization by the editor module 810).

It may be the case that this segment was ranked more highly than other usable segments because of, for example, the child's preference for the robot character (whether or not the robot appears due to a personalization), the child's previous rating of camera-based interactive segments or of art-based interactive segments, or due to a pending incentive of a box of crayons from a parent where both the segment and incentive share tags related to color. Any of these explanations would represent a customization by editor module 810.

An additional personalization that may be present is that the numerals and color names shown in buttons like 1512 and later in the segment may actually be handwriting samples entered by the child or a parent. Alternatively, the numerals and lettering might not be personalized and are instead provided within the segment assets, e.g., from a font or still artwork.

Still at 1510, the child is prompted to pick a color, and touchscreen sensor input 114 detects a press of button 1512. At 1520, the segment uses the selection 1521 from the child's button press, and instructs the child to take pictures of things that are blue.

At 1530, the camera, another instance of sensor 114, is activated; thumbnails of pictures already taken 1531 and placeholders 1532 for pictures still to be snapped are at the bottom of the screen; while viewfinder 1533 shows the camera's current view and button 1534 takes a picture when pressed.

At 1540, one or more of the pictures 1541 taken are evaluated by the interactive segment, in this case by determining whether a preponderance of pixels toward the middle of the image are the color blue. Reacting to an affirmative evaluation, the comment 1542 is shown and read in the character's voice.

At 1550, an award of a sticker 1551 (a system-provided virtual incentive) is made. At 1560, a follow-up activity is proposed, where at 1570, the robot character presents photos 1571 which supposedly “the character” has taken, but which are a personalization made using photographs actually taken by a parent or other family member and stored in user generated content from table 280. The child is prompted to indicate that the picture 1571 contains a “little blue” (button 1572), “more blue” (button 1573), or is “bluest” (button 1574), with the child's responses being compared to an automatic evaluation similar to that made at 1540, with the child's performance at the assessment contributing to a skill level (not shown).

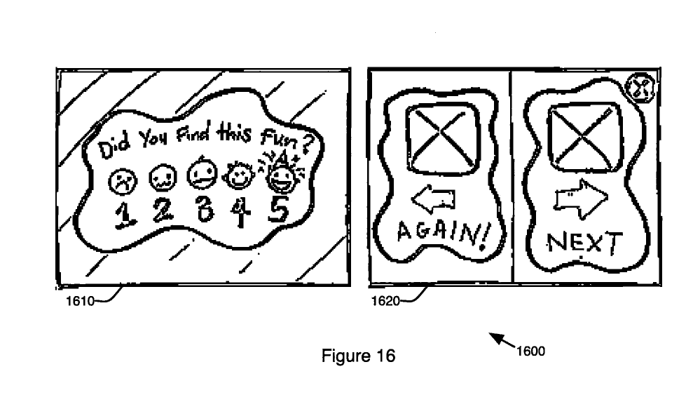

Following interactive segment 1500, FIG. 16 shows an evaluation opportunity 1610 where the child is explicitly asked to evaluate the segment, and a navigation screen 1620 which allows the child to revisit the interactive segment 1500. Note that in some embodiment, the explicit rating query 1610 is not required, as a child-facing camera (one of sensors 114) might use facial analysis software to assess the child's engagement and satisfaction during segment 1500. The result of that analysis may be used to adjust the “rating” field of the corresponding record in the personalized segment table 360.

As with all such systems, the particular features of the user interfaces and the performance of the processes, will depend on the architecture used to implement a system of the present invention, the operating system of the servers and database selected, the bandwidth and other properties of the network selected, and the software code written. It is not necessary to describe the details of such programming to permit a person of ordinary skill in the art to implement the processes described herein, and provide code and user interfaces suitable for executing the scope of the present invention. The details of the software design and programming necessary to implement the principles of the present invention are readily understood from the description herein. Various additional modifications of the described embodiments of the invention specifically illustrated and described herein will be apparent to those skilled in the art, particularly in light of the teachings of this invention. It is intended that the invention cover all modifications and embodiments, which fall within the spirit and scope of the invention. Thus, while preferred embodiments of the present invention have been disclosed, it will be appreciated that it is not limited thereto but may be otherwise embodied within the scope of the claims submitted.

### Possible Go Go Kiddo Customization and Personalization Criteria

### Customization Criteria

1. Primary Language
a. Comprehension level
b. Composition level
   i. Letter forms
c. Vocabulary level
d. Grammatical structure level
e. Spelling level
f. Narrative comprehension level
g. Narrative construction level

2. Secondary Language
a. Comprehension level
b. Composition level
c. Vocabulary level
d. Grammatical structure level
e. Spelling level
f. Narrative comprehension level
g. Narrative construction level

3. Mathematics
a. Comprehension level
   i. Number values
   ii. Addition
   iii. Subtraction
   iv. Division
   v. Decimal points
   vi. Fractions
   vii. Algebra
b. Composition level
   i. Number forms
   ii. Formula expressions
c. Abacus use level

4. Social Development Level
a. Each child has a progression through these social development “lessons”
b. Making friends
c. Sharing
d. Jealousy at birthday parties
e. Family
f. Brothers and sisters
g. etc

5. Emotional Development
a. Each child has a progression through these emotional development “lessons”
b. What are emotions?
c. Why do we feel sad?
d. How can we feel happy?

6. Physical Development
a. Potty training
b. Gross motor functions
c. Fine motor control
d. Balance
e. Muscle Development

7. Long form narratives
a. Some stories may be expressed over many segments and episodes so the system needs to track where the child is at within the larger story.

8. Parental Controls
a. Parents can select which content they want their child “exposed” to on axis such as:
   i. Family structures
   ii. Religions
   iii. Sexuality

9. Calendars of Events
a. Family Calendar
   i. Birthday celebrations
   ii. Anniversary celebrations
   iii. Family trips
   iv. Music lessons
   v. Recitals
b. School Calendar(s)
   i. A family may have kids in multiple schools
   ii. Start of classes
   iii. Days off
   iv. School plays or productions
   v. Holidays
   vi. Half days
   vii. Testing days
c. National Calendar(s)
   i. A family may observe more than one national calendar
   ii. 4^{th} of July
   iii. Presidents day
   iv. New Year's day
d. Cultural Calendar(s)
   i. Mexican day of the dead
   ii. Mardi Gras
e. Religious Calendar(s)
   i. A family may observe more than one religious calendar
   ii. Christmas
   iii. Passover
f. Sports Calendars
   i. Child's sports teams
      1. Games
      2. Practices
   ii. Professional teams
      1. Game days
g. Fictional Calendars
   i. Go Go Kiddo may create fictional holidays and events which would be observed
   ii. We may also incorporate other fictional holidays and events from other fictional works to be observed.
h. Unscheduled events
   i. There are special events which the parents can flag to cause episode segments about those events to be put into episodes asap.
   ii. Sibling birth
   iii. Cousin birth
   iv. Grandparent death
   v. Parent death
   vi. Sibling death
   vii. Moving to a new house
   viii. Moving to a new city
   ix. Changing schools
   x. Parents separating
   xi. Parents divorcing

10. Language(s) Spoken in the Household
a. English
b. Spanish

11. Family structure
a. Mom and dad
b. Single mom
c. Single dad
d. Two dads
e. Two moms
f. Living with grandparents

12. Local Knowledge and News
a. Episode segments might include content about the child's city and/or there may be news events which trigger episode segments, such as floods, fires
b. Local landmarks or items of interest
c. Local news (city/state)
d. National news (for all nationalities selected)

13. Environmental
a. Weather
   i. First snow
   ii. Raining
   iii. Sunny
   iv. Hot
b. Locations (Tagged GPS data)
   i. Child's home
      1. Mom's home
      2. Dad's home
   ii. Grandparents home
   iii. School
   iv. Dad's work
   v. Mom's work

14. Travel
a. GPS tracking can inform that the child is moving
   i. In a car
   ii. In a train
   iii. On a plane

15. Parent Selected or Purchased Incentives
a. Parents can trigger episode segments by their selecting or purchasing “in game” and real world items as incentives for their child's progress.

16. Child Profile
a. Age
b. Sex
c. Professional sports
   i. Favorite teams standings
   ii. Favorite teams statistics
   iii. Favorite players statistics
      1. Could be used to trigger segments when the child's favorite teams win or lose games, gain or lose players
   iv. Favorite teams news
d. Child's sports
   i. Team sports
      1. Child's team wins a big game
      2. Child's team loses a big game
      3. Child is cut from a team
      4. Child makes a higher level team
ii. Individual sports
   1. Favorites
      a. Skateboarding
   2. Favorite athletes
      a. Tony Hawk
e. Animals
   i. Favorite animals
      1. Lions
      2. Tigers
   ii. Pets
      1. Type
      2. Breed
      3. Name
      4. Age
      5. Birthday
f. Artistic pursuits
   i. Drawing
   ii. Painting
   iii. Building
   iv. Sculpture
g. Music
   i. Instruments that the child plays
      1. Piano
      2. Guitar
   ii. Favorite musicians
      1. News about band etc
      2. Upcoming concerts in child's area
h. Colors
   i. Favorite colors
i. Favorite entertainment
   i. Favorite TV shows
   ii. Favorite TV characters
   iii. Favorite Movies
   iv. Favorite Actors

### Personalization Content Types:

1. Parental content
a. Audio recordings
b. Photos

2. Parent selected or purchased incentives
a. Parents can trigger things to be inserted into episode segments by their selecting or purchasing “in game” and real world items as incentives for their child's progress.

3. Child content
a. Avatar design
b. Audio recordings
c. Photos
d. Art created within Go Go Kiddo

4. Travel
a. GPS tracking can inform that the child is moving
   i. In a car
   ii. In a train
   iii. On a plane

5. Environmental
a. Weather
   i. First snow
   ii. Raining
   iii. Sunny
   iv. Hot
b. Locations (Tagged GPS data)
   i. Child's home
      1. Mom's home
      2. Dad's home
   ii. Grandparents home
   iii. School
   iv. Dad's work
   v. Mom's work
c. News events
   i. There may be news events which trigger inserts into segments, such as floods, fires
   ii. Local news (city/state)
   iii. National news (for all nationalities selected)

6. Child Profile
a. Age
b. Sex
c. Name
d. Nick name
e. Professional sports
   i. Favorite teams standings
   ii. Favorite teams statistics
   iii. Favorite players statistics
      1. Could be used to trigger segments when the child's favorite teams win or lose games, gain or lose players, etc.
   iv. Favorite teams news
f. Child's sports
   i. Team sports
      1. Child's team wins a big game
      2. Child's team loses a big game
      3. Child is cut from a team
      4. Child makes a higher level team
   ii. Individual sports
      1. Favorites
         a. Skateboarding
      2. Favorite athletes
         a. Tony Hawk
g. Animals
   i. Favorite animals
      1. Lions
      2. Tigers
   ii. Pets
      1. Type
      2. Breed
      3. Name
      4. Age
      5. Birthday
h. Artistic pursuits
   i. Drawing
   ii. Painting
   iii. Building
   iv. Sculpture
i. Music
   i. Instruments that the child plays
      1. Piano
      2. Guitar
   ii. Favorite musicians
      1. News about band
      2. Upcoming concerts in child's area
j. Colors
   i. Favorite colors
k. Favorite entertainment
   i. Favorite TV shows
   ii. Favorite TV characters
   iii. Favorite Movies
   iv. Favorite Actors
l. Friends
   i. Names
   ii. Ages
   iii. Sexes
   iv. Photos
   v. Are they also Go Go Kiddo players?

7. Child performance data
a. Primary language
   i. Comprehension level
   ii. Composition level
      1. Letter forms
   iii. Vocabulary level
   iv. Grammatical structure level
   v. Spelling level
   vi. Narrative comprehension level
   vii. Narrative construction level
b. Secondary language
   i. Comprehension level
   ii. Composition level
   iii. Vocabulary level
   iv. Grammatical structure level
   v. Spelling level
   vi. Narrative comprehension level
   vii. Narrative construction level
c. Mathematics
   i. Comprehension level
      1. Number values
      2. Addition
      3. Subtraction
      4. Division
      5. Decimal points
      6. Fractions
      7. Algebra
   ii. Composition level
      1. Number forms
      2. Formula expressions
   iii. Abacus use level

1. A system for providing education and entertainment for children, comprising:
a first plurality of media segments;
a database comprising
first information related to a child,
second information related to the media segments;
a computer programmed to compose an episode by making a selection of a second plurality of media segments from the first plurality of media segments, the selection of media segments being made automatically on the basis of the second information and the first information; and,
a station having audio and video outputs, the station having access to the episode and the second plurality of media segments, the station operable to present the episode through the audio and video output by playing the second plurality of media segments;
whereby the episode is customized for the child.

2. The system of claim 1 further comprising:
a third plurality of templates; and,
wherein the database further comprises third information related to the templates,
the computer is further programmed to make a selection of a first template from the third plurality of templates on the basis of the first and third information,
each media segment has a kind, and
the first template specifies the kind required for each media segment in the episode.

3. The system of claim 2, wherein the database further comprises fourth information related to a calendar of events, and the selection of the first template is made on the further basis of the fourth information.

4. The system of claim 2, wherein the database further comprises fourth information related to weather, and the selection of the first template is made on the further basis of the fourth information.

5. The system of claim 1, wherein the database further comprises third information related to a calendar of events, and the selection of media segments is made on the further basis of the third information.

6. The system of claim 1, wherein the database further comprises third information related to weather, and the selection of media segments is made on the further basis of the third information.

7. The system of claim 1, wherein at least one of the second plurality of media segments is augmented with a second portion of the first information, whereby the episode is personalized for the child.

8. The system of claim 1, wherein the database further comprises user generated content related to the child, and least one of the second plurality of media segments is augmented with a portion of the user generated content, whereby the episode is personalized for the child.

9. The system of claim 8, wherein the user generated content is provided, at least in part, by a parent of the child.

10. The system of claim 1, wherein the first information is provided, at least in part, by a parent.

11. The system of claim 10, wherein the first information comprises facts about family members, the facts selected from a group comprising name, nickname, gender, role, height, birthday, hair color, race, ethnicity, religion, nationality, languages spoken, and contact information.

12. The system of claim 11, wherein the computer prompts the parent to update a first fact because an update to the first fact is due.

10. The system of claim 1, wherein episode is linear.

11. The system of claim 1, wherein episode is branching.

12. The system of claim 1, wherein episode is map-based.

15. The system of claim 1, wherein the first information comprises information selected from a group comprising how many times the child has been watched each media segment and how the child rated each media segment already watched.

16. The system of claim 1, wherein at least a portion of at least one of the first plurality of media segments is interactive, the station further comprising at least one sensor for use by the child when the interactive portion is playing.

17. The system of claim 16, wherein the station further comprises programming to determine a score for the child for each interactive media segment played, the score included in the first information for subsequent use.

18. The system of claim 1, wherein the database further comprises third information related to characters to appear in some of the media segments, and fourth information relating to how much the child likes the characters, and the evaluation further considers the third information against the fourth information.

19. The system of claim 1, the computer further programmed to provide a summary of the episode to a parent of the child.

20. The system of claim 1, wherein at least one of the second plurality of media segments is personalized with at least one of the current time-of-day and the current weather for the child's current location.

21. The system of claim 1, wherein the database comprises third information to indicate an incentive acquired by a parent of the child, and fourth information regarding award conditions for the incentive, the station further programmed to detect the award conditions being satisfied during the presentation of the episode and to award the incentive when the award conditions are satisfied.

22. A method for providing education and entertainment for children, comprising the steps of:
a) providing a first plurality of media segments;
b) providing a database comprising
first information related to a child,
second information related to the media segments;
c) automatically composing an episode by a computer programmed to making a selection of a second plurality of media segments from the first plurality of media segments, on the basis of the second information and the first information; and,
d) presenting the episode to the child on a station having audio and video outputs and access to the episode and second plurality of media segments, by playing the second plurality of media segments through the audio and video output;
whereby the child is provided with a customized episode.
